(19) United States
(12) Patent Application Publication
(10) Pub. No.: US 2018/0158246 A1
(43) Pub. Date: Jun. 7, 2018

(54) METHOD AND SYSTEM OF PROVIDING USER FACIAL DISPLAYS IN VIRTUAL OR AUGMENTED REALITY FOR FACE OCCLUDING HEAD MOUNTED DISPLAYS

(71) Applicant: Intel IP Corporation, Santa Clara, CA (US)

(72) Inventors: Oliver GRAU, Volklingen (DE); Daniel POHL, Saarbrucken (DE)

(21) Appl. No.: 15/372,030

(22) Filed: Dec. 7, 2016

(51) Int. Cl. G06T 19/00; G06K 9/00; G06T 17/10; G06T 3/00; G02B 27/01

(52) U.S. Cl. CPC G06T 19/006; G06K 9/00302; G06T 17/10; G02B 2027/0141; G02B 27/017; G02B 2027/0138; G02B 2027/014; G06T 3/0093

(57) ABSTRACT

A system, article, and method of providing user facial displays in virtual or augmented reality for face occluding head mounted displays.

### BACKGROUND

Head mounted displays (HMDs) are worn over the eyes and present images to a user wearing the HMD to provide the user a point of view (POV) in a virtual or augmented reality (also referred to as a virtual or augmented world). Multiple users may each have an HMD networked together so that all of the users experience the same virtual or augmented world except from a different personal point of view. For realities or worlds that permit the users to interact within the world, the users need to be able to see an avatar or representation of each other's face in the virtual or augmented world to communicate clearly with each other. One or more external cameras are typically positioned near the user, and pointed toward the user, to capture images of the user so that those images can be used to form an animation or very realistic representation of the user in the virtual or augmented world including the facial expressions and eyes of the user. A difficulty arises, however, because the HMD (or glasses) often block the view of the user's eyes and parts of the face in the external camera. Thus, these occluded parts of the face cannot be easily modeled to place accurate facial expressions on this part of the face on the representation of a user in the virtual or augmented world. As a result, multi-user virtual or augmented worlds that require clear face-to-face communication between the users in the world often provide a very unsatisfactory experience for the users.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1A is an image of a user wearing a head mounted display (HMD) according to the implementations provided herein;

FIG. 1B is an image of the user in FIG. 1A without the HMD and showing an image of the user as desired for a representation in a virtual or augmented reality according to the implementations provided herein;

FIG. 2A is an image of an eye from a representation in a virtual or augmented reality according to the implementations provided herein;

FIG. 2B is an image of actual eyes used to form the eye representation of FIG. 2B;

FIG. 3 is a schematic diagram of a system for generating a virtual or augmented reality according to the implementations provided herein;

FIG. 4 is a schematic diagram of an example image processing system used to implement the methods of providing user facial displays in virtual or augmented reality for face occluding head mounted displays according to the implementations herein;

FIG. 5 is a flow chart of a method of providing user facial displays in virtual or augmented reality for face occluding head mounted displays according to the implementations herein;

FIG. 6 is a detailed flow chart of a method of providing user facial displays in virtual or augmented reality for face occluding head mounted displays according to the implementations herein;

FIG. 7A is an image showing the features of an eye captured by an infra-red camera;

FIG. 7B is an image of eyes as desired on a representation in a virtual or augmented reality according to the implementations provided herein;

FIG. 8 is a schematic diagram of a system with both a head mounted display on a user and external camera according to the implementations provided herein;

FIG. 9 is a flow chart showing a method of learning an appearance model according to the implementations herein;

FIG. 10 is a flow chart showing a method of synthesizing facial images to a face model according to the implementations herein;

FIG. 11 is a flow chart showing a method of external camera synthesis according to the implementations herein;

FIG. 12 is a diagram of an operation of an example system described herein;

FIG. 13 is an illustrative diagram of an example system;

FIG. 14 is an illustrative diagram of another example system; and

FIG. 15 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as imaging devices, digital cameras, smart phones, webcams, video cameras, video game panels or consoles, set top boxes, and so forth, may implement the techniques and/or arrangements described herein be being, or being connected to, a head mounted display. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. The material disclosed herein may be implemented in hardware, firmware, software, or any combination thereof.

The material disclosed herein may also be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

Systems, articles, and methods of providing user facial displays in virtual or augmented reality for face occluding head mounted displays.

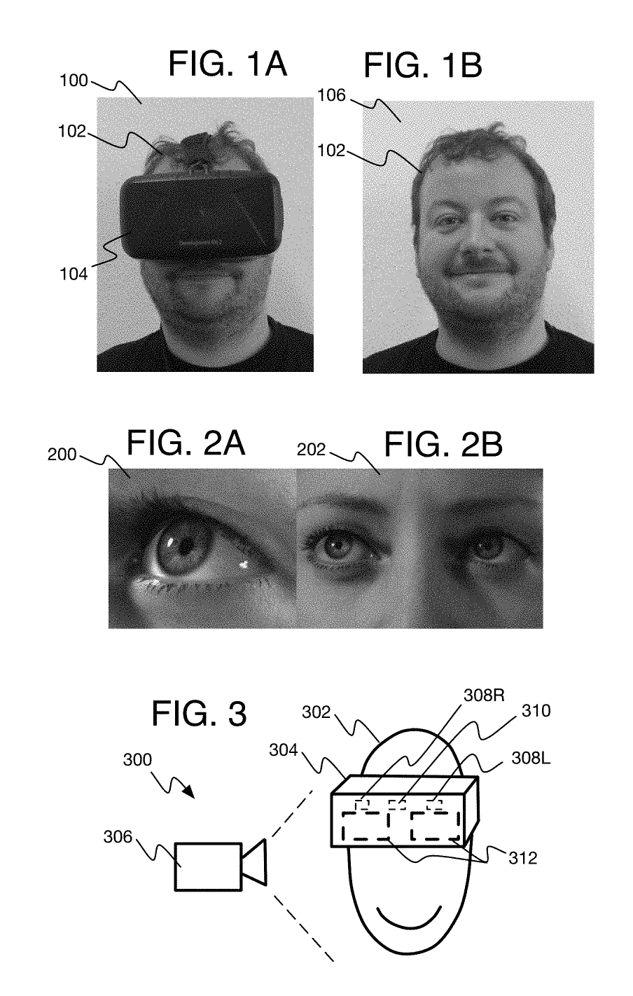

As mentioned above, clear communication between multiple users using networked head mounted displays (HMDs) is often hampered because the HMD on each user occludes the eyes and part of the face around the eyes (see images 100 and 106 of FIGS. 1A-1B as an example). This is true whether a virtual reality HMD is being used that entirely covers the eyes and face near the eyes, or augmented reality glasses are being used that are see-through but that can still block at least parts of the eyes and face near the eyes in images formed by an external camera. External and internal here are relative to the HMD device where farther from the face or user than the HMD device is considered external, while the area between the HMD and the face is considered internal. Thus, an external camera recording the face of a user cannot capture an image of that part of the face that is blocked, and in turn, cannot accurately model that part of the face in the virtual or augmented reality or world being formed with the HMDs.

One conventional solution is to place strain gauge motion sensors on the user's face so that motion of skin and muscle can indicate the appearance of the face that is occluded by the HMD. The sensors are mounted in the foam seams of the HMD placed against a user's face. The mouth area is recorded by an external camera. With this data, such a system can drive a facial expression model of an avatar. See, Li, Hao et al., Facial Performance Sensing Head-mounted Display, ACM Transactions on Graphics, Proceedings of the 42nd ACM SIGGRAPH Conference and Exhibition 2015 (August 2015). This approach, however, does not provide realistic results. The facial expressions are often inaccurate.

While realistic human eyes can be rendered in real-time using computer-generated rendering (see FIGS. 2A (virtual eye) and 2B (real eyes) as examples), these approaches are based on animation rather than actual video of a user. See for example, Unreal engine 4.11 update, www.unrealengine.com/blog/unreal-engine-4-11-released (as of November 2016).

While the term avatar may typically refer to an animation or cartoon-like representation of a person in a virtual or augmented reality versus a photo realistic representation, character, or model of a person, for simplicity and consistency sake, avatar as used herein may refer to either a synthetic avatar (SA) such as an animation or a photo-realistic avatar (PRA) that is generated by using video of a user. The avatar herein will generally refer to the whole body of the user while a photo-realistic face model forms the face of the avatar.

To resolve the issues mentioned above, the present method and system propose to augment the image of one or more external cameras with internal images of the occluded areas captured by one or more cameras mounted inside the HMD. This may be performed with closed virtual or augmented reality HMDs that completely cover a part of a user's face, as shown in FIG. 1A where an image 100 from an external camera has a face 102 of a user covered by a virtual reality HMD 104. Image 106 (FIG. 1B) shows the user's face 102 without the HMD (and without occlusions) and as desired for the face model in the virtual reality as discussed below. However, the methods herein also may apply to augmented reality formed by using see-though glasses that still may block the view of the face in the images of an external camera.

In more detail, the internal cameras could be RGB or RGB-D (RGB color sensor plus depth sensor) color cameras, and there may be one for both eyes, or a pair of such cameras with one for each eye. This, however, raises a number of difficulties regarding the lighting within a virtual reality HMD. The virtual reality HMDs conventionally enclose the internal area over the eyes in order to create a darkened space for better viewing of one or more displays in the HMD. This forms a space that is often too dark to capture images of the eyes and face around the eyes of the user wearing the HMD (also referred to as the occluded area relative to an external camera) when attempting to capture color images of the occluded area. Such an arrangement would need a flash or continuous light in order to capture a sufficient amount of color and light to provide useful images of the occluded area of the user. Such extra light, however, is not practical since it would cause a very distracting light and would blur if not completely saturate the view of the displays in the HMD.

To resolve these further difficulties, the internal cameras mounted on the internal side of the HMD and facing the eyes of the user may be infra-red (IR) cameras that do not require significant visible light to form the images of the occluded area, and will not interfere with the visibility of the display(s) in the HMD. With IR cameras, the color data is lost and the luminance or shading data is distorted due to the enclosed space on the HMD that may block all other light from entering the internal space. This results in great difficult in converting the IR image data to color data. However, this can be accomplished by learning an appearance model based on color video images and a 3D model to provide the position (or landmarks), color, brightness, and so forth for the occluded area. The images of the occluded area (whether from the IR images, color images of the face taken without the HMD, or both) are warped to the model for different facial expressions on the user. The appearance model then may provide a personal library of images of possible facial expressions for the occluded area. A synthesis operation is then used during the actual run of the HMD to match the actual internal images to appearance images in the appearance model to form an initial face model that is then filled where pixel data is missing. The face model is then blended with the rest of the user's avatar to form an avatar with a final face model. Also, it will be realized that even when the internal cameras are color cameras on a virtual reality HMD, the images in this case still must be modified by the appearance model and synthesized because colors and shading will be distorted due to the enclosed space under the HMD. Augmented reality glasses also may use this process due to distortions that still may be caused where the glasses cover the eyes and surrounding part of the face.

Referring to FIG. 3, a system 300 for displaying a virtual or augmented reality shows a user 302 wearing an HMD 304. One or more external capture devices or cameras 306 are positioned to face toward the user to record external images of the user wearing the HMD. By one form, the external cameras 306 are in fixed positions, and may be RGB or RGB-D cameras (or YUV or other types of cameras that convert to RGB data). By an alternative form, at least one external camera 306 is attached to the HMD by an arm for example so that it moves with the HMD. The external camera 306 may be positioned to capture just the head, head and shoulder, or whole body of the user although many variations may be used.

The HMD 304 may have one or more internal cameras pointed toward the face of the user 304, and particularly the eyes and area of the face around the eyes. The internal cameras may be a pair of right and left cameras 308R and 308L with one camera opposite each eye of the user 304. Alternatively, the internal camera could be a single centered camera 310, or other variations with more internal cameras and/or different placement of the cameras than that shown. The internal cameras may be infra-red cameras that have a projector and a sensor for sensing the reflected beams, but could alternatively have or include an RGB camera or sensor, or even an RGB-D camera or sensor especially for HMD see-through glasses for augmented reality that permit more outside light between the glasses and the user's face whether through the viewing panes of glass itself or through the open sides of the glasses. A covered HMD for virtual reality additionally or alternatively could have color cameras as well despite the distortion in color and lighting with the HMD. By one example approach, the internal camera may be viewing the eyes through (or on) a half mirror or other mirroring or prism light reflecting arrangements when such a design is desirable.

The HMD also may have displays 312 formed of screens facing the eyes of the user, often provided as one for each eye but a single display could be provided as well. The display shows the virtual or augmented reality to the user 304 so that the user is provided a personal point of view as if the user was within that displayed reality world.

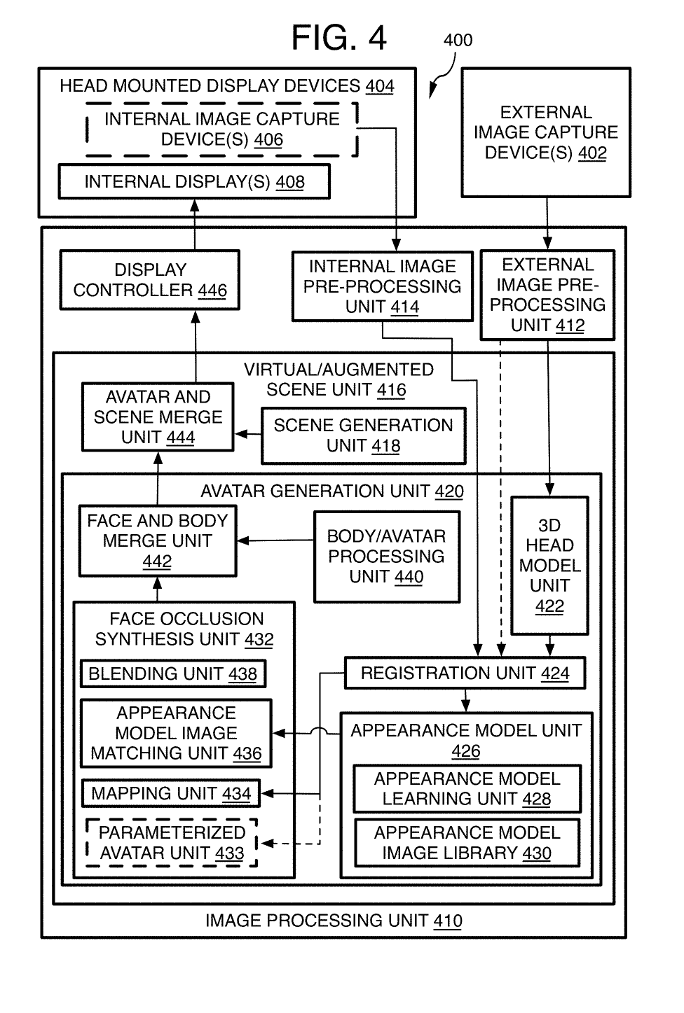

Referring to FIG. 4, an example image processing device or system 400 is shown for implementing the methods described herein. The image processing device 400 has one or more external image capture devices (or external cameras) 402 and one or more head mounted display devices (HMDs) 404 where at least one of the HMDs has internal image capture devices (or internal cameras) 406, such as the internal cameras 308 or 310 described with system 300. All of the HMDs 404 should have at least one internal display 408 to view the virtual or augmented world while a user wears the HMD.

Both the HMDs 404 and external cameras 402 are communicatively connected, either wirelessly or wired, to an image processing unit 410 that performs the method operations. The image processing unit 410 may be considered one or more separate devices. Thus, the image processing unit 410 may be a game box, TV box (e.g., a cable or satellite box), computer, remote server, smartphone, tablet, and so forth. Alternatively, the image processing unit 410 may be part of one or more of the HMDs or one or more of the cameras mentioned here such as the external cameras. In this case, the external cameras even may be mounted on the HMD itself to record at least the non-occluded parts of the face whether by an arm attaching the external camera(s) to the HMD or mounted directly on the HMD.

During an appearance model learning stage of generating the virtual or augmented reality, the color images of the external image capture device(s), which may be video images, may be provided to an external image pre-processing unit 412, while the IR or color images from the internal image capture devices 406 are provided to an internal image pre-processing unit 414, where both pre-processing units 412 and 414 apply pre-processing to raw image data sufficient to perform the 3D image processing to place the occluded image data from the internal image capture devices 406 onto the images and models formed with the external image capture device(s) 402. These pre-processing units may perform demosaicing, de-noising, filtering, color space conversions (such as YUV to RGB), resolution conversions, division into frames, and other pre-processing operations that may be needed for sufficient image processing desired as described herein. Other pre-processing operations may include depth-sensing, depth-processing, and background/foreground segmentation (or keying) to name a few examples. It will be appreciated that the pre-processing units 412 and 414 could be located on the HMDs and external cameras rather than the image processing unit 410.

The image processing unit 410 also has a virtual/augmented scene unit 416 that forms the content for the displays on the HMD. The virtual/augmented scene unit 416 may have a scene generation unit 418 that handles the background of the images, while an avatar generation unit 420 constructs the avatar of the user and for the images. The pre-processed image data from the external image capture device(s) 402 may be provided to a 3D head model unit 422 of the avatar generation unit 420. By one approach, external images taken while the user was wearing the HMD are provided to the 3D head model unit 422, while external images taken of the user in various poses and eye gaze directions without the user wearing the HMD are provided relatively directly to an appearance model unit 424 albeit first via a registration unit 424. Alternatively, the 3D head model (formed by unit 422) also may be based on external images of the user without the user wearing the HMD.

The 3D head model unit 422 uses the images of the external image capture device(s) 402 to form a 3D model of at least the face or head, but could be head and shoulder or more, of the user. Either the color images of the external image capture device(s) are warped to the 3D model, or the external image capture device(s) 402 are RGB-D cameras that already provide a three-dimensional space for the color pixel data. The 3D model may show the exterior of the HMD that is to be replaced by using the images from the internal image capture device(s) 404. The details are provided below. Thereafter, the 3D head model data also is provided to the registration unit 424.

The pre-processed internal image data from the internal image capture device(s) 404 then also may be provided to the registration unit 424. The registration unit 424 converts the different coordinate systems of the external and internal images into a single coordinate system (or generates conversion values) that indicates the position of the head and eyes. Due to the position of the HMD over the user's face, ideally the internal cameras are fixed in positon relative to the face. Thus, the internal and external images both may be registered to the 3D model or another generic registration model where the internal images provide the position of the actual face. Otherwise, either the external or internal images are registered to the 3D or generic model, which then may be converted into values of the other images (external or internal) as needed. Many variations are possible as long as the positions of the face content on the internal images can be determined relative to the positions of content on the external images. The details are provided below.

Once registered, the data is provided to an appearance model unit 426 that may use the 3D model formed by using the external image data. An appearance model learning unit 428 generates a library of images of possible facial expressions for the occluded face area of the particular user, and stores the images in an appearance model image library 430 that may be stored on any practical memory with sufficient capacity whether RAM, non-volatile, or other type of memory. The appearance model learning unit 428 may accomplish the generation of the library in a number of different ways. The cameras are operated during a preliminary run to learn or train the appearance model. By one form, during the learning stage, the internal and external images are both registered to the 3D model using the registration unit 424, and the occluded area of the face shown on the internal images are then warped to the 3D model. When a photo-realistic avatar is formed by using an RGB-D external camera, the parameters for warping all can be obtained from the IR images such as eye gaze points, eyebrow landmarks, and so forth. Then the 3D model need only be modified to match these parameters. Alternatively, when the external cameras are merely RGB (color without depth data), then more work needs to be performed to convert the IR images to color images to then warp the images to the 3D model. This may include (1) converting IR to color by using mapping functions, or (2) mapping IR and lighting from non-occluded parts of the face by using convolutional neural networks (CNNs).

By yet another alternative, the external camera(s) 402 may be used to capture images (preferably video but could be still photographs) of the user without wearing the HMD and before actual creation of the virtual or augmented reality so that the eyes and area around the eyes are captured in full color RGB or RGB-D. This may be performed for multiple head poses, eye gaze directions, and facial expressions, and the need to mold the IR images from the internal camera is avoided at least during the appearance model learning stage. The 3D model does not need to be formed for this option, and the non-HMD images of the user at different poses and different eye gaze directions may be stored as the appearance model images in the library.

Whether images are taken with or without the HMD being worn by the user, this process is repeated for each or multiple frames of a learning video sequence run provided by the internal and external cameras 402 and 406. The result is an appearance model for a user that has a library of stored 3D color images where each image shows at least possible facial expressions and eye gaze directions for the occluded area including the eyes and position of the eyebrows for example.

During the actual use of the HMDs and generation of the virtual world, the new video images from the internal and external cameras 402 and 406 are provided to the registration unit 424 as described above, and then provided to a face occlusion synthesis unit 432 to perform synthesis to compute an image of the occluded parts to be placed on external images. The synthesis operations may be performed in a number of different ways. When a photo-realistic avatar was formed using one or more RGB-D or RGB external cameras as the basis of the appearance model, library images of a parameterized avatar (in other words, images of the avatar are stored by parameters such as pose and exposed face area (e.g., left eye, nose, etc.) and an avatar head model are used to render the parameterized avatar by a parameterized avatar unit 433 that also then may mold the internal camera images to the parameterized avatar. The parameterized avatar model uses the available data from the outside sensors (RGB or RGB-D cameras) to form a representation of the user's head at the time.

Alternatively, when the external camera(s) is an RGB camera without depth measurement, then a mapping unit 434 maps the internal camera images to a face model (the 3D model), and then projects mapped internal images into a view of the external camera. This is a 2D to 2D transformation, which can be expressed in 2D or 3D coordinates and takes into account the relative positions of the involved cameras, derived from the camera registration. This also may be referred to as warping or projecting the internal images into an external image plane.

Next, an appearance model image matching unit 436 matches the mapped internal images to a matching occluded area image in the appearance model library 430 to generate a non-occluded image to be used on the avatar of the user. This also may be referred to as computing a synthetic image of the occluded parts. The matching is performed by matching algorithms such as sum of absolute differences (SADs) of face landmark points on the internal image and the non-occluded image from the library or by retrieving the occlusion from a CNN or similar machine learning technique. The matching algorithms are discussed in more detail below. This operation also may include filling holes with missing pixel image data, also discussed below.

Thereafter, blending operations may be applied that blends the external image with the synthetic image to complete the synthesis. This image or face model then may be merged by a face and body merge unit 442 with an avatar generated by a body/avatar processing unit 440. This may include an entire scene, or when the body of the avatar is treated differently from the background, the avatar then may be merged with an avatar and scene merge unit 444 that merges the avatar with a scene generation unit 418.

The scene with the avatar, or now a complete frame or image, may be provided to a display controller 446 that may be part of the image processing unit 410 or the HMD 404, and controls the display of the final images on the internal display(s) on the HMD. Other variations are possible where the final images are alternatively or additionally displayed on any other displays such as a computer, smartphone, TV, and so forth.

It will be appreciated that other components not shown may be provided for the system 400, such as those shown with systems 1300, 1400, and/or 1500 described below. It also will be appreciated that a depicted component includes code and/or hardware to perform the function of the depicted component and may actually be located in a number of different places or components on a device that collectively perform the recited operations of the depicted component.

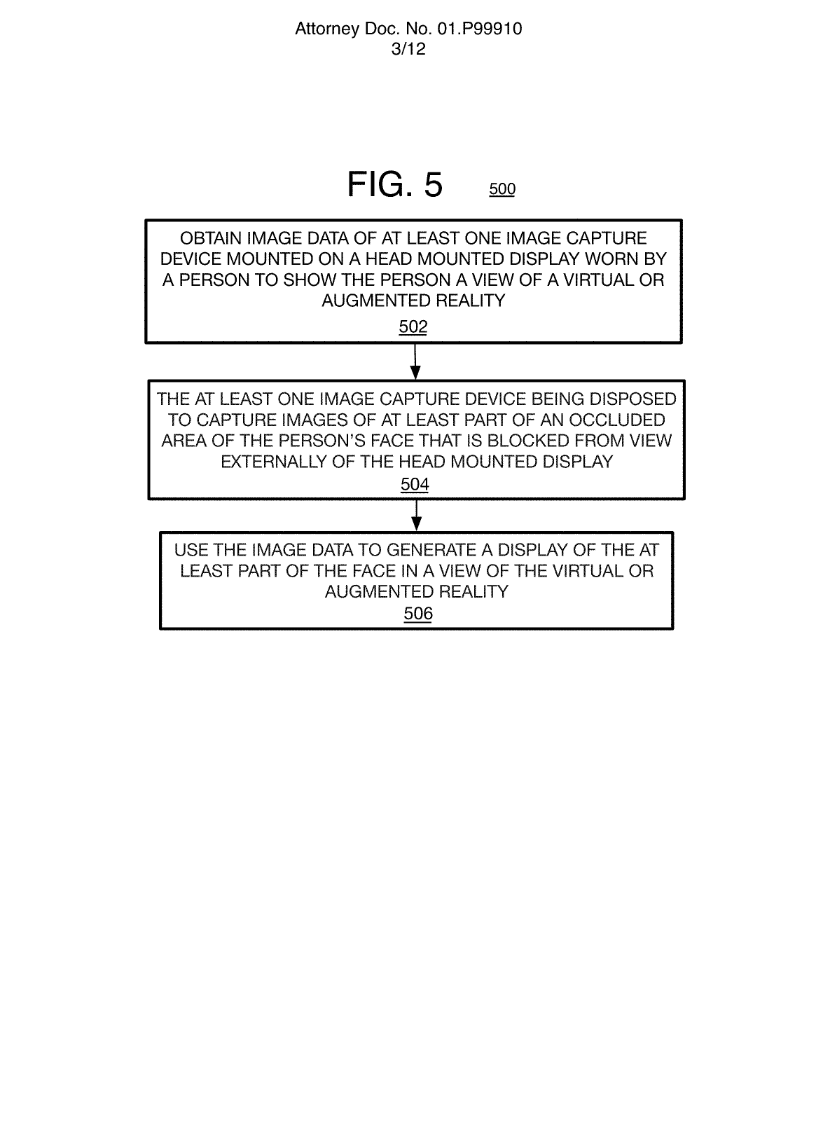

Referring now to FIG. 5, by one approach an example process 500 is a computer-implemented method of providing user facial displays in virtual or augmented reality for face occluding head mounted displays. In the illustrated implementation, process 500 may include one or more operations, functions or actions as illustrated by one or more of operations 502 to 506 numbered evenly. By way of non-limiting example, process 500 may be described herein with reference to example image processing systems 300, 400, 1300, 1400 or 1500 of FIGS. 3-4 and 13-15 respectively, and where relevant.

Process 500 may include “obtain image data of at least one image capture device mounted on a head mounted display worn by a person to show the person a view of a virtual or augmented reality” 502. As mentioned herein, the user wearing the HMD with one or more displays is shown images on display screens so that the user views a virtual or augmented reality which may be in point of view (POV) so it seems that the user is in the virtual or augmented reality.

Process 500 may include “the at least one image capture device being disposed to capture images of at least part of an occluded area of the person's face that is blocked from view externally of the head mounted display” 504. Thus, at least one internal image capture device is mounted inside the HMD or somewhere on the HMD where the internal capture device can capture images of the user's eyes and area of the face surrounding the eyes that is at least partly covered by the HMD or at least partly blocked from view in external cameras facing the user wearing the HMD. The external camera(s) are used to generate an avatar of the user which could be anything from just the face to the entire body of the user. By one form, there is at least one internal image capture device for each eye in the HMD.

Process 500 may include “use the image data to generate a display of the at least part of the person's face in a different view of the virtual or augmented reality” 506. By one approach, this refers to multi-users each with an HMD networked together to view different perspectives of the same virtual or augmented reality. At least one of the HMDs has the internal image capture devices, and the image of that user's face including the occluded area may be displayed at the HMD of at least one other user. Other variations could be used as well where the display of the occluded area of the user's eyes and face around the eyes are displayed on another display rather than on an HMD of a multi-user.

By one example, the images of the occluded area of the face and from the internal image capture device is placed on images from one or more external image capture devices recording the user to form an image of the whole face. This involves a learning stage and a run (or run-time, or use) stage. During the learning or training stage, an appearance model may be learned which includes either generating a library of 3D color appearance images that are specific to the user wearing the HMD with the internal camera, or generating a personal 3D color avatar of at least the user's face. Once the appearance model is generated, the HMD can be used to operate the virtual or augmented reality with other users to communicate clearly and face-to-face in the reality world. The generation of the appearance model and the use of appearance images to determine a final image for display may be accomplished in a number of different ways depending on whether the exterior camera is an RGB-D depth camera or not, and whether or not the external camera was used to record video or obtain images of the user without wearing the HMD as explained below. By one approach, generation of individual appearance images could be omitted when an RGB-D external camera is used to form an avatar as the appearance model. Otherwise, during the run-time stage when the virtual or augmented reality is being operated, most of the implementations include comparing infra-red (IR) internal images obtained during use to the previously determine library of appearance images to find the best matching appearance image. The selected appearance image of the occluded area of the user's face is then blended with a corresponding external image and any missing pixel data may be filled in. The final image then may be displayed in the HMD to a second or more users so those additional users can view the full face of the first user. Many details are provided below.

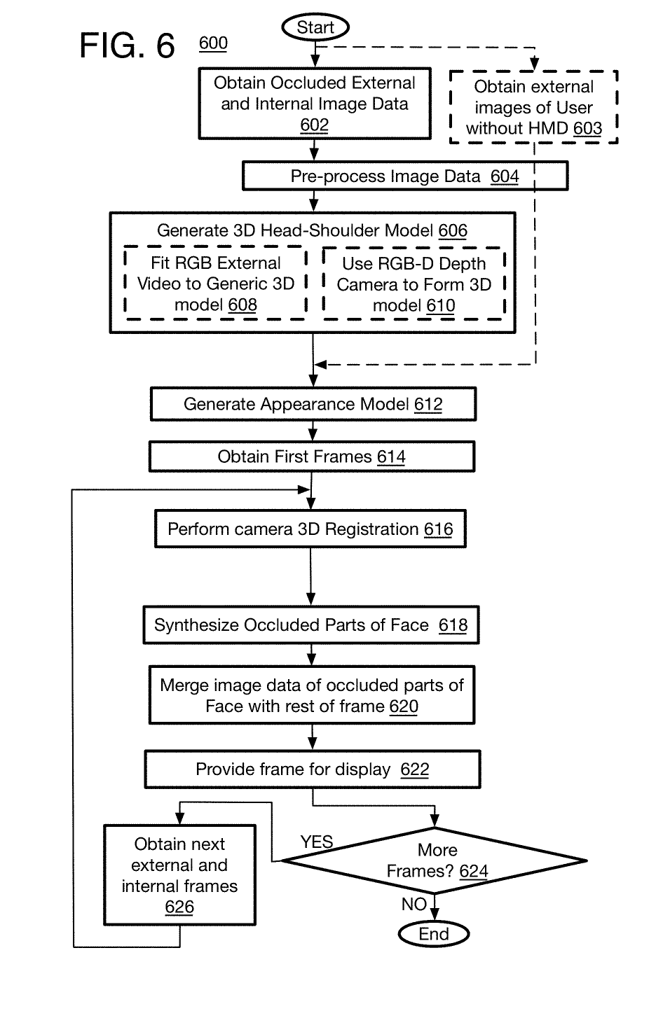

Referring now to FIG. 6, by one approach an example process 600 is a computer-implemented method of providing user facial displays in virtual or augmented reality for face occluding head mounted displays. In the illustrated implementation, process 600 may include one or more operations, functions or actions as illustrated by one or more of operations 602 to 626 numbered evenly. By way of non-limiting example, process 600 may be described herein with reference to example image processing systems 300, 400, 1300, 1400 or 1500 of FIGS. 3-4 and 13-15 respectively, and where relevant.

Process 600 may include “obtain occluded external and internal image data” 602. This refers to obtaining raw image data from external and internal image capture devices. The external image capture device may be an RGB camera (without depth data) or an RGB-D depth camera that provides depth data (where each sampled pixel location has (x, y, z) coordinates on a depth map). The external cameras also could be a YUV camera that is converted to RGB when needed. One or more of the external cameras may be placed near a user wearing a head mount display (HMD) as described above and with the internal image capture devices. The external camera may be in a fixed location relative to the user and HMD, or otherwise attached to the HMD or user to be fixed relative to the user, similar to a selfie extension arm. The external camera may be located to record video of the user during use of the HMD to place the user in a virtual or augmented reality formed by using the HMDs. This may include recording just the face or head of the user, but in many circumstances will include recording at least the head and shoulders of the user, from the waist up on the user, and/or the entire body of the user. The external camera also may be used for a learning stage as described below.

As mentioned more than one external camera may be used, and by one form, to record all or most sides of the user when possible. Multiple external cameras may be networked together to form a complete synthetic or photo-realistic avatar of the user. The external camera also may be used to set the entire scene in the virtual or augmented reality to provide a view to another user. The external camera(s) may provide external raw pixel image data (whether RGB, RGBD, or YUV) to the system for processing.

As to the internal image capture device (or camera), one or more internal cameras may be mounted in or on the HMD where the internal camera has a clear view of at least the user's eyes and area of the face around the eyes. By one form, there is one internal camera in front of each eye area of the user in the HMD. This is an area of the face typically entirely covered and hidden by a virtual reality HMD, but is often also obscured and partly blocked by augmented reality smartglasses for example. This is often referred to as the occluded area, relative to the external camera, that is visible to the internal camera but is blocked in the view of the external camera. The area visible to the internal camera also may be referred to as a part of the occluded area because in most cases, even the internal cameras will have some blockage between its camera sensor and the user's face by HMD structure over the bridge of the nose for example or other structure of the HMD or user's face itself. Thus, even the internal camera may not be able see the entire occluded area.

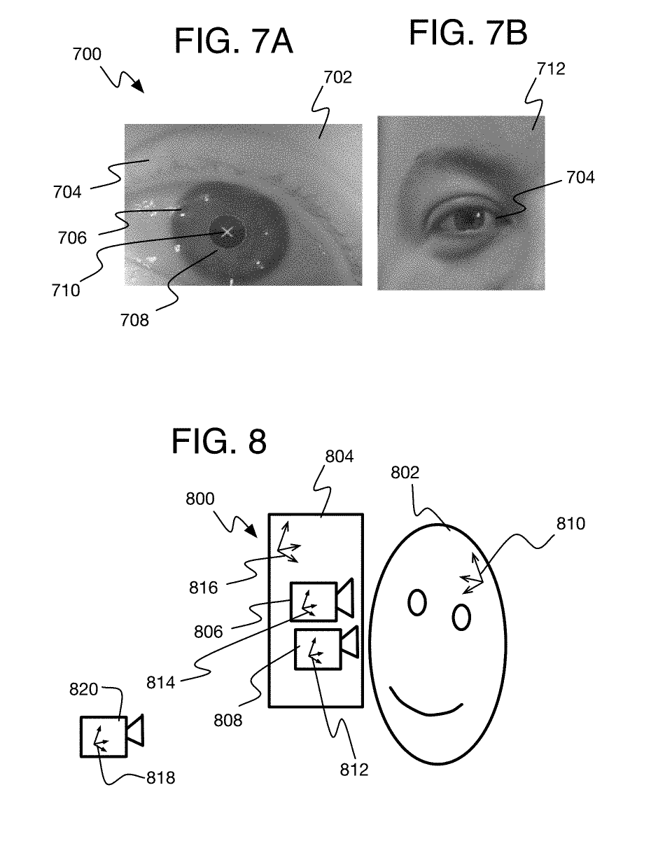

Referring to FIGS. 7A-7B, and also as mentioned, while the internal cameras could be RGB or other color space cameras, the internal cameras will be assumed to be infra-red (IR) cameras that need little or no light to obtain images of face structure. Such camera operation is shown for system 700 that has an image 702 of an eye 704 from an IR camera compared to a color image 712 showing the same eye 704. From detection of the eye iris 706, pupil 708, and x marking the center of the pupil 710, an eye gaze direction can be determined by known processes. A 3D full color image 704 can be re-constructed by using the IR images and additional information on the (inverse) mapping. Thus, while color data is lost with the IR camera, the eye gaze direction as well as other structure on the occluded area can be preserved such as the eye shape, eye lid position and shape, eyebrow position and shape, wrinkles in the face and so forth can still be picked up. Also, it would be possible to drive synthetic eye models or use the data for image retrieval (instead of SAD retrieval mentioned above). Alternatively, the internal cameras could be monochrome, YUV, RGB, or RGB-D.

During operation of the HMD, the system obtains occluded external images, or in other words, external images of the user wearing the HMD so that the HMD itself shows up in the images. During a learning stage, these occluded external images still can be used as well. Optionally, however, process 600 may include “obtain external images of user without HMD” 603. Thus, such images then may contain the images of the entire face of the user including the occluded areas. Either way, during the learning stage, the user may be asked to provide a series of different head or face poses, a variety of facial expressions, and a variety of eye gaze directions to be recorded either only while the HMD is being worn by the user, or both with the HMD on and off of the user. The HMD should be on to record variations of learning images for the internal camera, while the HMD may be on or off as mentioned to record learning images for the external camera(s). The determination as to whether or not to require the wearing of the HMD for the external cameras may depend on convenience or difficulty in using the equipment as well as other factors.

During the learning stage to generate an appearance model, a library of appearance images may be generated for matching to the internal IR images during run-time. Depending on the type of camera used (whether depth camera or not), such non-occluded images may be used to provide an appearance model in the form of an avatar without recording a library of appearance images as described below.

Process 600 may include “pre-process image data” 604. This operation may include demosaicing, de-noising, filtering, color space conversions, resolution conversions, division into frames, and other pre-processing operations that may be needed to apply sufficient image processing to raw image data to form image data that can be used to generate an avatar for the virtual or augmented reality. This also may include detecting and tracking facial landmarks with object detection, depth-sensing, depth-processing (creating a 3D map or space with objects in a captured scene), and background, foreground, and/or object segmentation (or keying) to name a few examples.

Process 600 also may include “generate 3D head-shoulder model” 606, and this refers to building an initial 3D model that can be used to warp the internal images into 3D and color, and is first used for learning an appearance model and generating appearance images. The 3D model generally fixes the location of the external images to the face via the internal images. Thus, when the external cameras are color cameras without depth data, process 600 also may include “fit RGB external video to generic 3D model” 608. Generic models are described, for example, for video coding applications (see, J. Ahlberg, CANDIDE-3—an updated parameterized face, Report No. LiTH-ISY-R-2326, Dept. of Electrical Engineering, Linköping University, Sweden, 2001). A generic model is adapted to a real person's face by identifying specific points (such as eyes, nose, the corners of the mouth, and so forth) in the image and mapping it to the model. The color external images from the external camera then may be fitted or warped to the generic 3D model by methods as described in the paper by Ahlberg and others. While in one form, a head and shoulder model is generated, it will be appreciated that the 3D model needs to be at least a model of a face, or just the head, or could be more than the head and shoulder.

By another option, when the external camera(s) are RGB-D depth cameras, process 600 may include “use RGB-D depth camera to form 3D model” 610. Thus, the RGB-D camera already provides color data as well as depth data so that the 3D model could be an initial head avatar of the user in a single pose for an entire learning or use session. In this case, the avatar is simply mapped from the image data rather than fitting of external images onto a 3D model in a single pose. Instead, this 3D model or avatar could be formed individually for each frame or a sequences of frames. The 3D model mentioned here is formed with the user wearing the HMD so that the HMD is visible on the initial 3D models, and require internal images to replace the HMD on the models.

Also as mentioned as an alternative, the creation of a 3D model as a basis for forming appearance images in an appearance model may be omitted when an RGB-D camera is used to capture external images of the user without wearing the HMD. Thus, the appearance images may be omitted in favor of a 3D color avatar as the appearance model. The details are provided below.

Process 600 then may include “generate appearance model” 612. Thus, when the external cameras are non-depth cameras, or when depth cameras are being used as the external cameras, but the external images only capture images of the user wearing the HMD, then an appearance model may be generated having a library of appearance images. When an RGB-D depth camera is used as the external camera (or at least one of the external cameras), then the appearance model may or may not provide the appearance images. The appearance model could be the 3D model avatar showing the full face of the user instead.

The appearance model is to provide a variety of different possible (1) head or face poses, (2) facial expressions which may include at least differences in eye and eyebrow position and shape, but could also include shape and position of an eyelid, eyelash, and wrinkles near the eyes, and (3) eye gaze direction. Other details of the eyes may include shading of the eyes including subsurface scattering through the sclera, caustics on the iris, specular on the wet layer of the eye, refraction from the cornea, darkening of the limbal ring, dilation of the pupil, and so forth. The appearance model is based at least in part on the personal features (or parameters) of the user so that the resulting avatar is recognizable as the user (or associated with the user) in the virtual or augmented reality.

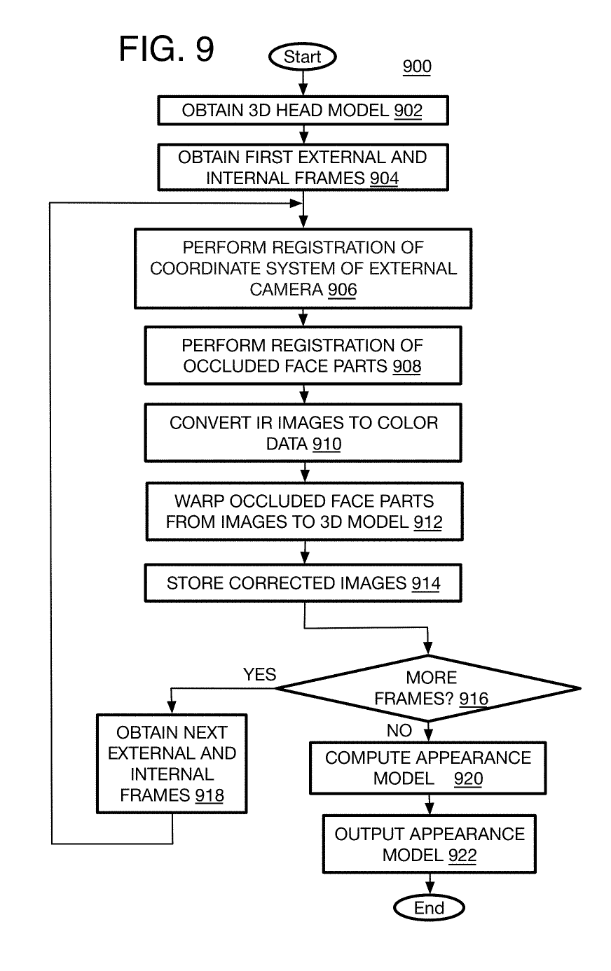

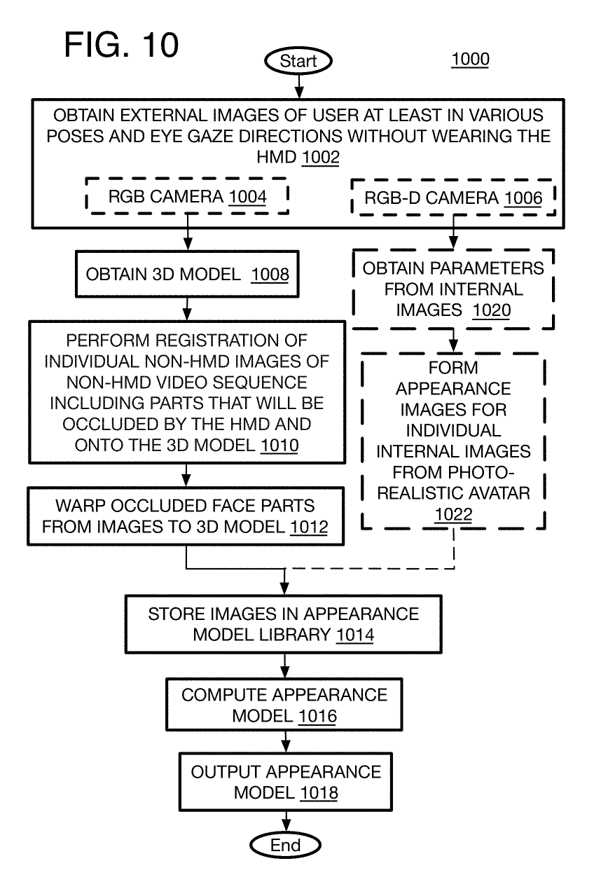

Referring to FIG. 9, the process 900 regards one way to generate the appearance model. Process 900 also applies whether or not the external cameras are RGB cameras or RGB-D cameras but when only external images with the user wearing the HMD are available. Process 1000 (FIG. 10) covers the case when the external cameras can be used to capture images without the user wearing the HMD. Thus, by one approach, example process 900 is a computer-implemented method of providing user facial displays in virtual or augmented reality for face occluding head mounted displays, and particularly to the learning of an appearance model with external images that include the user wearing the HMD so that the exterior side of the HMD is visible in the images. In the illustrated implementation, process 900 may include one or more operations, functions or actions as illustrated by one or more of operations 902 to 922 numbered evenly. By way of non-limiting example, process 900 may be described herein with reference to example image processing systems 300, 400, 1300, 1400 or 1500 of FIGS. 3-4 and 13-15 respectively, and where relevant.

Process 900 may include “obtain 3D head model” 902, and as mentioned this may actually be the 3D head and shoulder model, but could be just the model of at least a face of the user, or could be more than the head and shoulders. The 3D model is formed as discussed above for process 600. The result is a 3D model provided in color and that is personal to the user.

Process 900 may include “obtain first external and internal frames” 904. Thus, the process may proceed frame by frame where the external and internal cameras are recording a video to respectively form the external and internal images. For a learning or training session, the user will be told to provide different poses, facial expressions, and/or eye gaze directions for the video. The poses include the position and orientation of the head, and which direction the face is facing, An eye gaze direction refers to the direction that the eyes are facing. This also may include different facial expressions, from happy to sad, angry, surprised, and so forth including any expression that may change the position and shape of the eyes and the face around the eyes, including position and shape of the cheeks near the eyes, eye lids, eye brows, wrinkles near the eye, and so forth. As mentioned, in this case, the internal cameras are providing the occluded face area while the external images only provide the face with the user wearing the HMD so that the eyes of the user cannot be seen.

Corresponding external and internal images are obtained that were captured at the same time or at least within a desired interval, such as about 30 ms to match the approximate capture time of 30 fps video, and within plus or minus one frame.

Referring to FIG. 8, the process 900 then may include “perform registration of coordinate system of external camera” 906. As shown on system 800, a user 802 is wearing an HMD 804 that has internal cameras 806 and 808, one for each eye, and an external camera 820 is disposed to capture images of the user here wearing the HMD. Each component has its own three-dimensional coordinate system as does the user's face. The coordinates of the user's face is represented by an axis 810, while each internal camera has its own axes 812 or 814 which both may be registered to an HMD axis 816. The external camera 820 may have an axis 818.

The relative pose (position and orientation) of the head to the external camera already may be derived from the generic head model or 3D model since after fitting external images to the model, the relative pose is known. In order to improve robustness and accuracy any information from the HMD such as orientation or position can be used for this purpose if available (Oculus and HTC provide this information). Since the registration from the internal camera coordinate system to the 3D model is already accomplished, the registration from the internal camera to the external camera is now complete. A transformation matrix (hand-eye transformation) for converting coordinates of the external images to the 3D model is computed and then may be used to register the external cameras to the internal cameras, and in turn the occluded face parts shown on the internal images.

Process 900 may include “perform registration of occluded face parts” 908. Specifically, to some degree, the internal camera axis can be assumed to be fixed relative to the head, as the user should be wearing the HMD in the same way. Therefore, the relative coordinate systems of the internal cameras depend only on the type of the HMD and the mounting of the cameras. Also, the internal camera coordinate systems and the HMD coordinate system are fixed to each other as well and will be known. Thus, the coordinates of the HMD or each internal camera when handled separately are assumed to be the coordinates of the head. The registration of the internal cameras to the 3D model is accomplished by either matching features of the internal cameras to the prior captured appearance model or to a generic face model.

The registration could be performed with each frame, but may need to be checked only one time for each HMD learning and use session. Ideally, the registration is checked periodically to ensure that the HMD has not moved relative to the user's face since the user should typically wear the HMD in the same fixed way.

Once the external and internal cameras are registered to the 3D model and each other, process 900 may include “convert IR images to color data” 910. When the internal cameras are IR cameras, the IR data should be converted to chroma pixel values in order to place the occluded face parts on to the 3D model. If the internal cameras are RGB color cameras, then the conversion operation may be omitted.

For the conversion, this may be accomplished in a number of different ways. When the external cameras are RGB-D cameras and the 3D model is a 3D color avatar, the conversion may take place by merely using a few parameters (referred to as action units) from the internal images such as eye gaze points and eyebrow shape and location data for example. The basic shapes, color, and shading are already on the avatar.

When the external cameras are non-depth cameras, then the IR to color conversion may be performed by a mapping function using a limited neighborhood of pixels (such as 1, 4, 8, higher order) to form a combination value (RGB) for a single color value for a pixel. The mapping can be implemented by means (averages) codebooks or other machine learning methods.

By another example, either alternatively or additionally, a neural network, such as a convolutional neural network (CNN) may be used to map the IR and lighting from non-occluded parts of the face. Neural networks (like CNNs) can take multiple inputs, in this case the external and internal images, and maps this to the anticipated facial image. The mapping would be trained using a training set that contains many examples of different persons under different lighting conditions. The mapping makes use of the registered and warped images, but could also work on unwarped images.

Process 900 may include “warp occluded face parts from images to 3D model” 912. Specifically, the result is a mapping to effectively remove the pixel data that represents the HMD itself, and replace it with the image data from the internal images that show the occluded area of the user's face. The process includes a warping (or re-projection) of the captured examples as a normalization operation here. Thus, the face model here may be in a standard position, for example, looking straight forward.

As the warping is technically a re-projection, by one form, it can be implemented as an inverse texture mapping using a 3D mesh M with vertices Vᵢ∈R³ and including first projecting each vertex Vi into an image U from a known position (from registration data) here called “Pos”, then generating a texture coordinate vᵢ∈R², and then using the image U together with texture coordinates vᵢ to render a new image from position U′. Alternatively, the same process can be formulated as a 2D process including first finding 2D triangles for the new position (which might require projecting 3D vertices Vᵢ into target image), finding a 2D-2D coordinate transform to warp triangle by triangle from input image to target image, where finding the 2D-2D transform may require the same operations as described above for the 3D case, but can then be implemented as a 2D process.

Process 900 then may include “store corrected images” 914, wherein each corrected or appearance image may be stored. The appearance images may be formed for every set of corresponding internal and external images or some set random or uniform sampling of images. As mentioned for the learning of the appearance model, the images should cover a range of different face or head poses, various facial expressions which may include eyebrow shape and position data as well as other features, and various eye gaze directions. It will be understood that the appearance images may be ordered in a library that permits faster access and location of certain matching images. Thus, images may be indexed by pose, facial expression, eye gaze direction, and/or other feature or parameters on one or multiple levels or directories (folders).

Process 900 then may include the query “more frames?” 916, and when more frames do exist, process 900 may include “obtain next external and internal frames” 918, and the process loops to operation 906 to repeat the process with the next set of external and internal frames. If not, process 900 may include “compute appearance model” 920. The decision (916) can be based on an empirical rule of how many example poses should be taken of one user. This process can be embedded into a user interface (UI) that asks the user to pose differently in front of the camera(s) or even can be asked to press a button when he is in the pose. Alternatively an automatic process can be developed that checks when enough data in different poses has been captured and then stops.

Once complete, process 900 may include “output appearance model” 922, which may include permitting access to the appearance images on a memory and that form the appearance model for the use or run-time of the HMD. This also may include retrieving the appearance model and transmitting it to a local device performing the processing of the virtual or augmented reality when the appearance model is generated or stored remotely, such as at a server over the internet for example.

Referring to FIG. 10, an alternative process 1000 to generate the appearance model may be used when the external camera images include images of the user without wearing the HMD. By this approach an example process 1000 is a computer-implemented method of providing user facial displays in virtual or augmented reality for face occluding head mounted displays, and particularly to the learning of an appearance model by using external non-occluded images of the user without wearing the HMD. In the illustrated implementation, process 1000 may include one or more operations, functions or actions as illustrated by one or more of operations 1002 to 1016 numbered evenly. By way of non-limiting example, process 1000 may be described herein with reference to example image processing systems 300, 400, 1300, 1400 or 1500 of FIGS. 3-4 and 13-15 respectively, and where relevant.

The process 1000 may include “obtain external images of user at least in various poses and eye gaze directions without wearing the HMD” 1002. The poses include the position and orientation of the head, and which direction the face is facing. An eye gaze direction refers to the direction that the eyes are facing. This also may include different facial expressions, from happy to sad, angry, surprised, and so forth including any expression that may change the position and shape of the eyes and the face around the eyes, including position and shape of the cheeks near the eyes, eye lids, eye brows, wrinkles near the eye, and so forth. This is performed without the user wearing the HMD so that the eyes and the face around the eyes are fully visible

The following operations for generating the appearance model may depend on whether an “RGB camera” 1004 without depth data is being used as the external camera, or an “RGB-D camera” 1006 that provides depth data is being used as the external camera. When the RGB camera without depth data is being used, the next operation is to “obtain 3D model” 1008, and as described above, the 3D color model that is made personal to the user due to the external images is obtained, or at least access to the model on a memory is provided. The external images used to form the 3D model could be occluded images with the user wearing the HMD, but if possible, the 3D model would be formed with the same images without the HMD as well. The 3D model may include 3D color pixel points in a single pose of the user that forms at least the face, but could be the entire head and shoulder, or more, of the user as well.

The process 1000 then may include “perform registration of individual non-HMD images of non-HMD video sequence including parts that will be occluded by the HMD and onto the 3D model” 1010, and as registration is already described above for process 900 to locate the non-occluded external images onto the 3D model.

The process 1000 may include “warp occluded face parts from images to 3D model” 1012. Thereafter, the occluded face parts, or more precisely, the face parts that will be occluded once covered by the HMD, are now warped to the 3D model, and this may include the various poses, facial expressions, and eye gaze directions, to generate a set of appearance images of the appearance model, one image for each or some sampling of facial variations in the images. This may be provided by the non-HMD external images themselves rather than the need to use any internal images at this stage. Such warping is as described above with operation 912 of process 900 where internal images were warped to the 3D model when the HMD was being worn by the user in the external images.

The process 1000 may include “store images in appearance model library” 1014, and as mentioned above for process 900, the appearance images are stored and indexed in a memory, and may be stored in a certain order as mentioned above for process 900.

Thereafter, the process 1000 may include “compute appearance model” 1016, which refers to the structure for storing the appearance model library. This may include, depending on the type of appearance model, storing the sample images in a suitable way (called lib of appearance image, including indexing as described above). Otherwise, another option is to include computing parameterized models, for example, to separate face orientation from eye-gaze, mimic parameters, etc., as described in Paul Ekman & Wallace V. Friesen, Facial Action Coding System: A Technique for the Measurement of Facial Movement, Consulting Psychologists Press, Palo Alto, Calif. Lastly, another option is to use machine learning, for example, a CNN method.

The process 1000 may include “output appearance model” 1018, which refers to making the appearance model accessible also as mentioned above with process 900.

In the alternative where the external camera capturing the images of the user without the HMD is an RGB-D camera that provides depth data, the process 1000 may include “obtain parameters from internal images” 1020. Thus, at least the eye gaze direction and pose may be obtained from internal images. The external images would be used to construct the color 3D model avatar as mentioned with process 600, and would not necessarily be saved as separate images.

Thus, the process 1000 may include “form appearance images for individual internal images from photo-realistic avatar” 1022 to form the library of appearance images. For this alternative, the external non-occluded images could be used to form the individual appearance images if this is more convenient or efficient and supported, and where each appearance image has some variation in the user's face or pose as described above. Further, it is possible to combine learning from graphics rendered images (computer graphics imagery (CGI)) with real images.

It will be appreciated that in one alternative, when using RGB-D external cameras and the appearance model is learned by obtaining external images of the user without wearing the HMD, the generation of a library of appearance images may be omitted altogether. Instead, the 3D avatar formed from the RGB-D data of the external camera and set as the 3D model may be used as a 3D color avatar that establishes the appearance model. In this case, individual internal images are not used in the learning stage although such internal images still will be used in the actual run stage. This may be similar to a fully CGI generated avatar. The details for such application of the 3D avatar are provided below.

The remaining operations for establishing the appearance model are the same as that with the non-depth camera.

Returning now to process 600, the HMD may be used to perform a run-time or use stage versus the learning or training stage. Now the HMD is worn by at least one user, and most likely a number of users where the HMDs are networked together to view different perspectives of the same virtual or augmented reality. At least one of the users has an HMD with the one or more internal cameras. Accordingly, process 600 may include “obtain first frames” 614, and particularly, to obtain the first external frame of the user wearing the HMD with the internal camera(s) and the corresponding internal frames or images that show at least part of the occluded area that is blocked from view of the external camera(s) by the HMD. Thereafter, the external camera will provide external images, and the internal camera will provide the internal images as described above.

Thereafter, process 600 then may include “perform camera 3D registration” 616, and as already explained above for the learning stage, the location of the internal images may be registered to a 3D model, and the 3D model may be registered to the external images, thereby generating a conversion to apply to internal images to compute external image locations. This may be the same single pose 3D model generated for the appearance model learning stage.

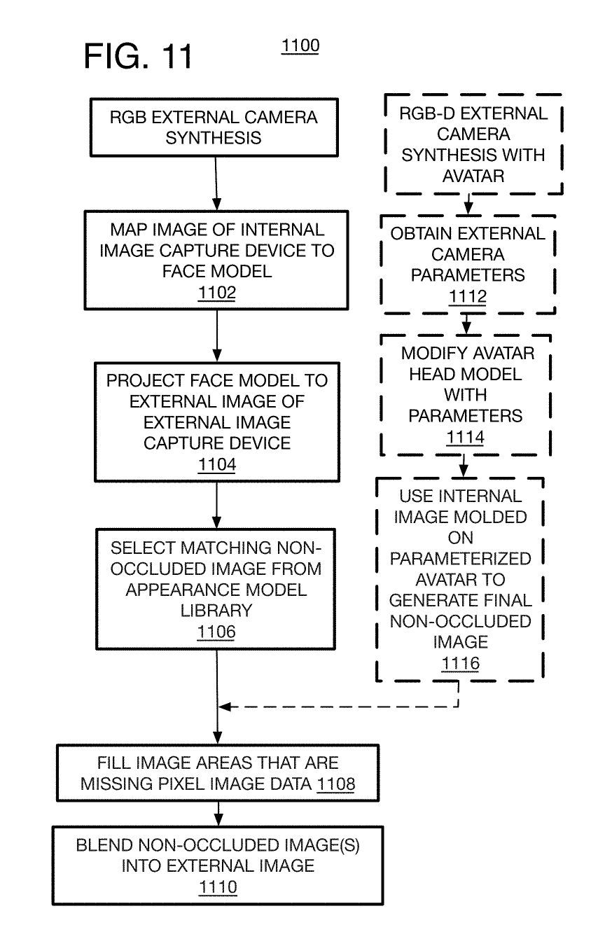

Referring to FIG. 11, process 600 then may include “synthesize occluded parts of face” 628. This may include the operations of process 1100. By one approach, example process 1100 is a computer-implemented method of providing user facial displays in virtual or augmented reality for face occluding head mounted displays, and particularly to the synthesis of the occluded image (the internal image from the internal camera). In the illustrated implementation, process 1100 may include one or more operations, functions or actions as illustrated by one or more of operations 1102 to 1116 numbered evenly. By way of non-limiting example, process 1100 may be described herein with reference to example image processing systems 300, 400, 1300, 1400 or 1500 of FIGS. 3-4 and 13-15 respectively, and where relevant.

The synthesis module computes an image of the occluded parts, which may be referred to as a synthesized image (or final image after refinement for display). This also can be performed in a number of different ways depending on whether the external camera is a depth camera or not. Thus, the process 1100 has two different branches, one for RGB external camera synthesis and another for RGB-D external camera synthesis with an avatar.

When the external camera(s) are RGB cameras without depth data, the process 1100 may include “map image of internal image capture device to face model” 1102, or in other words, mapping (or warping or projecting) the internal image to the 3D model. This is performed as described above. See operation 912 of process 900 for example.

Then, the process 1100 may include “project face model to external image of external image capture device” 1104. Here, warping methods that record and index viewpoints and motion of humans may be used. See, F. Xu et al., Video-Based Characters—Creating New Human Performances from a Multi-view Video Database, ACM Transactions on Graphics (TOG) 30.4 (2011): 32. Here, a look-up table or index search may be performed with the occluded parts in the internal images of the internal cameras to find a matching stored appearance image, and where the external occluded image is the key or base image. The selected appearance image found by performing a lookup in the library or database of stored appearance images can then be used to replace the occluded part of the external image. This is a more condensed, patch-type process versus storing and replacing entire faces which would require many more samples from a particular individual. This may be referred to as a ‘spectrum’ since particular pixels or pixel sections could be replaced to form the occluded area. The pixel-level replacement may result in a face that still needs much refinement, somewhere between particular pixels that needs replacement but not as much as entire holistic faces that need to be repaired.

The look-up uses standardized image sizes, and can be achieved since the face model and camera position and orientation are known. The standard size can be produced by projecting the face model into an image using a projection matrix of a virtual camera position, i.e., a standard position to achieve a defined size of the facial image.

The process 1100 may include “select matching non-occluded image from appearance model library” 1106, or in other words, generate the non-occluded image employing the appearance model. Thus, the matching or indexing is performed by using the information from internal and external cameras and determined, for example, using a SAD-based matching. Other matching functions can be found through machine learning techniques that find a more robust indexing function. Examples are a learning separation function based on neural networks, support vector machine (SVM), or cluster techniques.

The process 1100 may include “fill image areas that are missing pixel image data” 1108, and as mentioned above, the internal cameras may only be able to view a part of the occluded area on the face so that reconstruction or warping of the internal image, or parts of it, to the external image may still leave some areas on the external image previously covered by the HMD to now be without any pixel data. These unfilled areas then may be filled in by interpolation or other hole filling techniques when the occluded image found in the look-up table in the library does not provide the missing data as described above.

The process 1100 may include “blend non-occluded image(s) into external image” 1110. The blending takes into account slight differences in shading and color from the external image to the internal image. This may include applying interpolation algorithms that can be determined spatially on a single frame, and/or could include temporal blending over a number of consecutive frames in a sequence to provide for accurate images as well as smooth transitions from one pose to another for example. Optionally, a more robust blending technique may be used when the results are still rough, and may include varying the frame to frame rate of the blending depending on the rate of change of the image data (whether a stable flat area or an area with quick changes in color and/or brightness from frame to frame). See, for example, W. Paier et al., Video-Based Facial Re-Animation, Proc. European Conference on Visual Media Production (CVMP), London, UK (Nov. 2015). The blending can be guided with a mask of missing parts. This can be identified by comparing the expected image areas as found by the projected face model with the occluded area.

By the other alternative mentioned with the use of an RGB-D camera where an avatar has been generated already, an image of the parameterized avatar may be rendered using the external camera parameter and avatar head model. Specifically, process 1100 may include “obtain external camera parameters” 1112, and this may include the pose of the head, a facial expression on at least that part of the face that is visible on the external images outside of the HMD on the user's face, and so forth.

The process 1100 then may include “modify avatar head model with parameters” 1114, where the parameters from the external images are used to modify or set the color and depth of the features of the face on the avatar.

The process 1100 then may include “use internal image molded on parameterized avatar to generate final non-occluded image” 1116. Accordingly, the internal images are then warped to the now modified or parameterized avatar to show the occluded parts on the avatar. This would include the eye gaze direction, eyebrow position, and other features that cannot be seen clearly from the external images due to the HMD covering the occluded area on the external images. The remainder of the process 1100 is the same as that for the RGB camera without depth data.

Now returning again to process 600 that may include “merge image data of occluded parts of face with rest of frame” 620. Now, the occluded parts then may be merged with the remainder of the face, if not done already, then head, and then body. Also if treated separately and not treated integrally within the exterior images, the resulting full body avatar then may be merged with a background scene image partly or wholly taken from the external images.

The resulting image can be used as it is in video conferencing applications or it can be used as a texture map together with the 3D head model. In the latter case, the receiver can adjust for slight differences between position of the external camera and a (virtual) position of the peer observer. This would allow generation of an image with corrected eye-lines (the user looks into the face of the peer observer).

Process 600 may include “provide frame for display” 622, where the final image or frame is provided for further post-processing and then to a display controller to display on the HMDs of the users other than the user of the HMD with the internal cameras. The final image may be added to a set of images used to form the entirety of the virtual or augmented reality where the different images are registered to each other to form a 3D space, and then different perspectives may be provided for different users that do not have the perspective of the exterior images. In this case, the resulting image from the synthesis may not be displayed but is used as a tool to form the 3D virtual or augmented world.

Process 600 may include the query “more frames?” 624, and when more frames are present in the video sequence being formed by the internal and external cameras, the process 600 may include “obtain next external and internal frames” 626, and the process loops back to operation 616 to analyze the next set of frames or images.

It will also be understood that while the process has been discussed in terms of a single internal image provided with a single external image, there can be more than one internal image, such as one image for each eye, and each eye or each internal image perspective can be merged together in the registration and synthesis operations. Thus, any operation that can be performed with the single internal image, can also be performed with multiple internal images. Thus, an occluded feature looked-up in a single search could be a feature that extends over multiple internal image views.

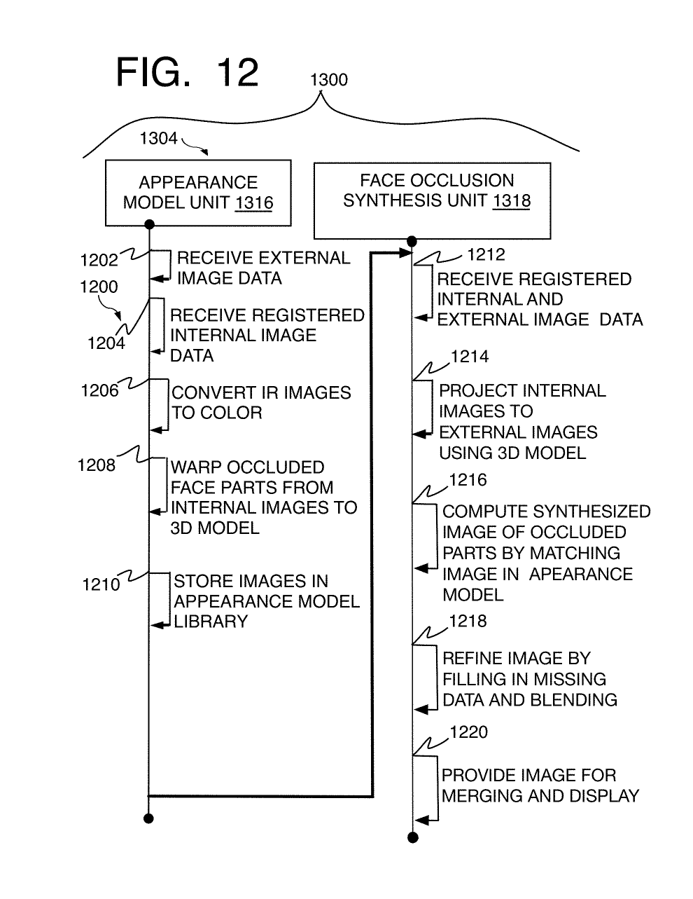

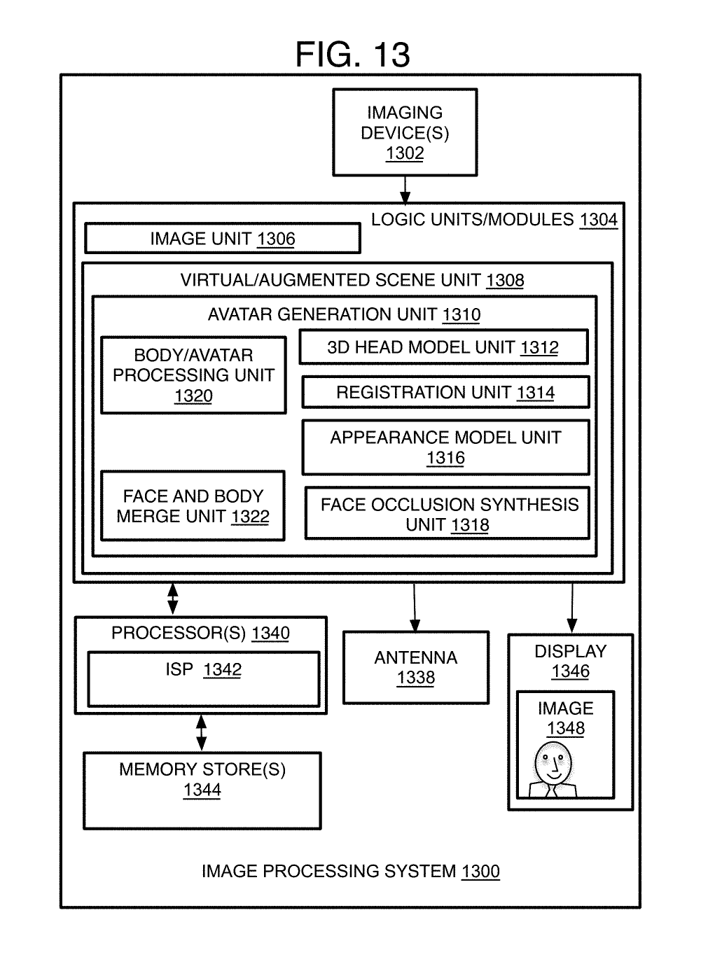

Referring to FIG. 12, process 1200 illustrates the operation of a sample image processing system 1300 that performs a method of providing user facial displays in virtual or augmented reality for face occluding head mounted displays. In more detail, in the illustrated form, process 1200 may include one or more operations, functions or actions as illustrated by one or more of actions 1202 to 1220 numbered evenly. By way of non-limiting example, process 1200 will be described herein with reference to FIG. 13. Specifically, system 1300 includes logic units 1304 that has a virtual/augmented scene unit 1308 that has an avatar generation unit 1310. This unit may have a 3D head model unit 1312, registration unit 1314, appearance model unit 1316, face occlusion synthesis unit 1318, body/avatar processing unit 1320, and a face and body merging unit 1322. Relevant here, the operation of the appearance model unit 1316 for the learning stage and face occlusion synthesis unit 1318 for the use or run-time stage may proceed as follows.

The process 1200 may include “receive external image data” 1202, and as explained above, this may be with or without the user wearing an HMD, as explained above.

The process 1200 may include “receive registered internal image data” 1204, also as explained above, involves registering the external images to a 3D model, and then registering the internal images to the same 3D model resulting in registration of the internal images to the external images.

The process 1200 may include “convert IR images to color” 1206, and as explained above, a number of techniques may be used to perform the conversion, and depending on whether RGB non-depth or RGB-D depth cameras are used. The details are explained above.

The process 1200 may include “warp occluded face parts from internal images to 3D model” 1208. The warping is explained in detail above, and may be provided for a variety of different internal camera parameters, whether eye gaze direction, facial expression, pose, and so forth. The warping is also as described above.

The process 1200 may include “store images in appearance model library” 1210, and as mentioned above, this may index the appearance images in some searchable order, and could be by occluded part such as eye, eyebrow, and so forth. The details are provided above.

The process 1200 may include “receive registered internal and external image data” 1212. This includes the same registration as mentioned above for the learning side, except that now the external images are limited to images that show the user wearing the HMD if not done so during the learning stage. Again, the details are provided above.

The process 1200 may include “project internal images to external images using 3D model” 1214, and this includes performing the mapping of the occluded parts to the external images (or external image plane) as already described above as well. Thus, the occluded parts are transformed to be consistent with the coordinates of the external image. In other words, the occluded parts are transformed in a 3D coordinate transform including a translation plus rotation of the internal camera coordinate system relative to the external camera (as it is relative to the face that might move). See operation 1104 above.

The process 1200 may include “compute synthetic image of occluded parts by matching image in appearance model” 1216. The matching operation chooses the closest appearance image to the present internal image, or at least the occluded parts in the internal image adjusted to the external plane as mentioned in the previous operation, and which can be less than the entire internal image. It could be a very small part of the internal image down to a per pixel implementation with small patches (e.g. 3×3 IR pixels) as input to the appearance mapping function (e.g., IR 3×3 input plus the position and other detail may result in 1 RGB pixel output). The operations to perform the matching are provided above.

The process 1200 may include “refine image by filling missing data and blending” 1218, and as described above, interpolation or other algorithms may be applied to fill missing data in the occluded area shown in the synthesized image, and/or to blend image data temporally from frame to frame, or from one area of a frame to another area of frame to provide smooth transitions between areas of different color and/or shading to form a final refined image. This process may be repeated for each or individual sampled internal images.

The process 1200 may include “provide image for merging and display” 1220, and the final image with the occluded area may be merged with other views of the same perspective including the remainder of the face, head and body to form an entire avatar, and then merging with a background shown in the exterior images. Also as described above, the final refined image may be provided to form a view of the virtual or augmented reality that can be registered with other perspectives of the reality to form a 3D space for the reality. Then images of other perspectives of the 3D space can be formed for other HMDs networked to the HMD providing the internal images.

It will be appreciated that the processes 500, 600, 900, 1000, 1100, and 1200 respectively explained with FIGS. 5-6 and 9-12 do not necessarily have to be performed in the order shown, nor with all of the operations shown. It will be understood that some operations may be skipped or performed in different orders.

Also, any one or more of the operations of FIGS. 5-6 and 9-12 may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more of the operations of the example processes herein in response to program code and/or instructions or instruction sets conveyed to the processor by one or more computer or machine-readable media. In general, a machine-readable medium may convey software in the form of program code and/or instructions or instruction sets that may cause any of the devices and/or systems to perform as described herein. The machine or computer readable media may be a non-transitory article or medium, such as a non-transitory computer readable medium, and may be used with any of the examples mentioned above or other examples except that it does not include a transitory signal per se. It does include those elements other than a signal per se that may hold data temporarily in a “transitory” fashion such as RAM and so forth.

As used in any implementation described herein, the term “module” refers to any combination of software logic, firmware logic and/or hardware logic configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth. For example, a module may be embodied in logic circuitry for the implementation via software, firmware, or hardware of the coding systems discussed herein.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

Referring to FIG. 13, an example image processing system 1300 is arranged in accordance with at least some implementations of the present disclosure. In various implementations, the example image processing system 1300 may have one or more imaging devices 1302 to form or receive captured image data, and this may include either one or more external cameras, one or more internal cameras on an HMD or both. Thus, in one form, the image processing system 1300 may be a digital camera or other image capture device that is one of the external or internal cameras. In this case, the imaging device(s) may be the camera hardware and camera sensor software, module, or component. In other examples, imaging processing system 1300 may have an imaging device 1302 that includes, or may be, one of the internal or external cameras, and logic modules 1304 may communicate remotely with, or otherwise may be communicatively coupled to, the imaging device 1302 for further processing of the image data.

Accordingly, the part of the image processing system 1300 that holds the logic units 1304 that processes the images may be on one of the cameras or may be on a separate device included in or entirely forming the image processing system 1300. Thus, the image processing system 1300 may be a desktop or laptop computer, remote server, or mobile computing device such as a smartphone, tablet, or other device. It also could be or have a fixed function device such as a set top box (cable box or satellite box), game box, or a television. An HMD may or may not be considered part of the image processing system 1300. When present, internal image capture device(s) 1302 and at least one display 1346 may be considered to form an HMD or be located on an HMD. When the imaging device(s) 1302 also include external cameras, these external imaging devices may be considered physically remote from the rest of the image processing system 1300. Whether internal or external cameras 1302, the cameras may be wirelessly communicating, or wired to communicate, image data to the logic units 1304.

In any of these cases, such technology may include a camera such as a digital camera system, a dedicated camera device, web cam, or any other device with a camera to be the external video camera for the HMD operation but could have, or also be, a still camera for appearance model learning. The external camera may be an RGB camera or an RGB-D camera, but could be a YUV camera. The internal camera may be an RGB or YUV color camera, monochrome camera, or an IR camera with a projector and sensor. Thus, in one form, imaging device 1302 may include camera hardware and optics including one or more sensors as well as auto-focus, zoom, aperture, ND-filter, auto-exposure, flash, actuator controls, and so forth.

The logic modules 1304 of the image processing system 1300 may include, or communicate with, an image unit 1306 that performs at least partial processing. Thus, the image unit 1306 may perform pre-processing, decoding, encoding, and/or even post-processing to prepare the image data for transmission, storage, and/or display. In the illustrated example, the logic modules 1304 also may include a virtual/augmented scene unit 1308 that has an avatar generation unit 1310. This unit may have a 3D head model unit 1312, registration unit 1314, appearance model unit 1316, face occlusion synthesis unit 1318, body/avatar processing unit 1320, and a face and body merging unit 1322 that perform many of the operations described above. These units may be operated by, or even entirely or partially located at, processor(s) 1340, and which may include an image signal processor (ISP) 1342 to perform many of the operations mentioned herein. The logic modules 1304 may be communicatively coupled to the components of the imaging device 1302 in order to receive raw image data.

The image processing system 1300 may have one or more of the processors 1340 which may include the dedicated image signal processor (ISP) 1342 such as the Intel Atom, memory stores 1344 which may or may not hold the appearance models as well as other image data or logic units mentioned above, and antenna 1338. In one example implementation, the image processing system 1300 may have a display 1346, which may or may not be one or more displays on the HMD, at least one processor 1340 communicatively coupled to the display, and at least one memory 1344 communicatively coupled to the processor to perform the operations described herein as explained above. The image unit 1306, which may have an encoder and decoder, and antenna 1346 may be provided to compress and decompress the image date for transmission to and from other devices that may display or store the images. This may refer to transmission of image data between either the internal cameras or external cameras, and the logic units 1304. Otherwise, the processed image 1348 may be displayed on the display 1346 or stored in memory 1344. As illustrated, any of these components may be capable of communication with one another and/or communication with portions of logic modules 1304 and/or imaging device 1302. Thus, processors 1340 may be communicatively coupled to both the image device 1302 and the logic modules 1304 for operating those components. By one approach, although image processing system 1300, as shown in FIG. 13, may include one particular set of unit or actions associated with particular components or modules, these units or actions may be associated with different components or modules than the particular component or module illustrated here.

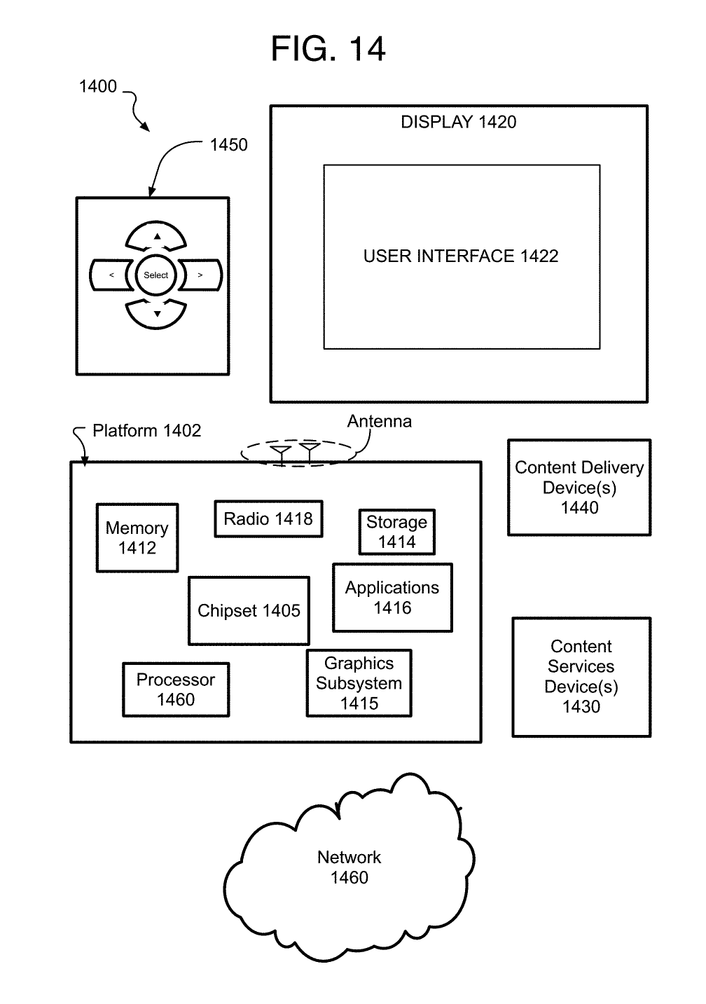

Referring to FIG. 14, an example system 1400 in accordance with the present disclosure operates one or more aspects of the image processing system described herein. It will be understood from the nature of the system components described below that such components may be associated with, or used to operate, certain part or parts of the image processing systems described above including performance of HMD operation, virtual or augmented reality generation, and/or operation of the external and internal cameras described above. In various implementations, system 1400 may be a media system although system 1400 is not limited to this context. For example, system 1400 may be incorporated into a digital video camera, mobile device with camera or video functions such as an imaging phone, webcam, personal computer (PC), remote server, laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 1400 includes a platform 1402 coupled to a display 1420. Platform 1402 may receive content from a content device such as content services device(s) 1430 or content delivery device(s) 1440 or other similar content sources. A navigation controller 1450 including one or more navigation features may be used to interact with, for example, platform 1402 and/or display 1420. Each of these components is described in greater detail below.

In various implementations, platform 1402 may include any combination of a chipset 1405, processor 1410, memory 1412, storage 1414, graphics subsystem 1415, applications 1416 and/or radio 1418. Chipset 1405 may provide intercommunication among processor 1410, memory 1412, storage 1414, graphics subsystem 1415, applications 1416 and/or radio 1418. For example, chipset 1405 may include a storage adapter (not depicted) capable of providing intercommunication with storage 1414.

Processor 1410 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1410 may be dual-core processor(s), dual-core mobile processor(s), and so forth.

Memory 1412 may be implemented as a volatile memory device such as, but not limited to, a Random Access Memory (RAM), Dynamic Random Access Memory (DRAM), or Static RAM (SRAM).

Storage 1414 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1414 may include technology to increase the storage performance enhanced protection for valuable digital media when multiple hard drives are included, for example.

Graphics subsystem 1415 may perform processing of images such as still or video for display. Graphics subsystem 1415 may be a graphics processing unit (GPU) or a visual processing unit (VPU), for example. An analog or digital interface may be used to communicatively couple graphics subsystem 1415 and display 1420. For example, the interface may be any of a High-Definition Multimedia Interface, Display Port, wireless HDMI, and/or wireless HD compliant techniques. Graphics subsystem 1415 may be integrated into processor 1410 or chipset 1405. In some implementations, graphics subsystem 1415 may be a stand-alone card communicatively coupled to chipset 1405.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further implementations, the functions may be implemented in a consumer electronics device.

Radio 1418 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1418 may operate in accordance with one or more applicable standards in any version.

In various implementations, display 1420 may include any television type monitor or display. Display 1420 may include, for example, a computer display screen, touch screen display, video monitor, television-like device, and/or a television. Display 1420 may be digital and/or analog. The display 1420 also may be a display on an HMD as described above. In various implementations, display 1420 may be a holographic display. Also, display 1420 may be a transparent surface that may receive a visual projection. Such projections may convey various forms of information, images, and/or objects. For example, such projections may be a visual overlay for a mobile augmented reality (MAR) application. Under the control of one or more software applications 1416, platform 1402 may display user interface 1422 on display 1420.

In various implementations, content services device(s) 1430 may be hosted by any national, international and/or independent service and thus accessible to platform 1402 via the Internet, for example. Content services device(s) 1430 may be coupled to platform 1402 and/or to display 1420. Platform 1402 and/or content services device(s) 1430 may be coupled to a network 1460 to communicate (e.g., send and/or receive) media information to and from network 1460. Content delivery device(s) 1440 also may be coupled to platform 1402 and/or to display 1420.

In various implementations, content services device(s) 1430 may include a cable television box, personal computer, network, telephone, Internet enabled devices or appliance capable of delivering digital information and/or content, and any other similar device capable of unidirectionally or bidirectionally communicating content between content providers and platform 1402 and/display 1420, via network 1460 or directly. It will be appreciated that the content may be communicated unidirectionally and/or bidirectionally to and from any one of the components in system 1400 and a content provider via network 1460. Examples of content may include any media information including, for example, video, music, medical and gaming information, and so forth.

Content services device(s) 1430 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1402 may receive control signals from navigation controller 1450 having one or more navigation features. The navigation features of controller 1450 may be used to interact with user interface 1422, for example. In implementations, navigation controller 1450 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1450 may be replicated on a display (e.g., display 1420) by movements of a pointer, cursor, focus ring, or other visual indicators displayed on the display. For example, under the control of software applications 1416, the navigation features located on navigation controller 1450 may be mapped to virtual navigation features displayed on user interface 1422, for example. In implementations, controller 1450 may not be a separate component but may be integrated into platform 1402 and/or display 1420. The present disclosure, however, is not limited to the elements or in the context shown or described herein.

In various implementations, drivers (not shown) may include technology to enable users to instantly turn on and off platform 1402 like a television with the touch of a button after initial boot-up, when enabled, for example. Program logic may allow platform 1402 to stream content to media adaptors or other content services device(s) 1430 or content delivery device(s) 1440 even when the platform is turned “off.” In addition, chipset 1405 may include hardware and/or software support for 8.1 surround sound audio and/or high definition (7.1) surround sound audio, for example. Drivers may include a graphics driver for integrated graphics platforms. In implementations, the graphics driver may comprise a peripheral component interconnect (PCI) Express graphics card.

In various implementations, any one or more of the components shown in system 1400 may be integrated. For example, platform 1402 and content services device(s) 1430 may be integrated, or platform 1402 and content delivery device(s) 1440 may be integrated, or platform 1402, content services device(s) 1430, and content delivery device(s) 1440 may be integrated, for example. In various implementations, platform 1402 and display 1420 may be an integrated unit. Display 1420 and content service device(s) 1430 may be integrated, or display 1420 and content delivery device(s) 1440 may be integrated, for example. These examples are not meant to limit the present disclosure.

In various implementations, system 1400 may be implemented as a wireless system, a wired system, or a combination of both. When implemented as a wireless system, system 1400 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1900 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1402 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 14.

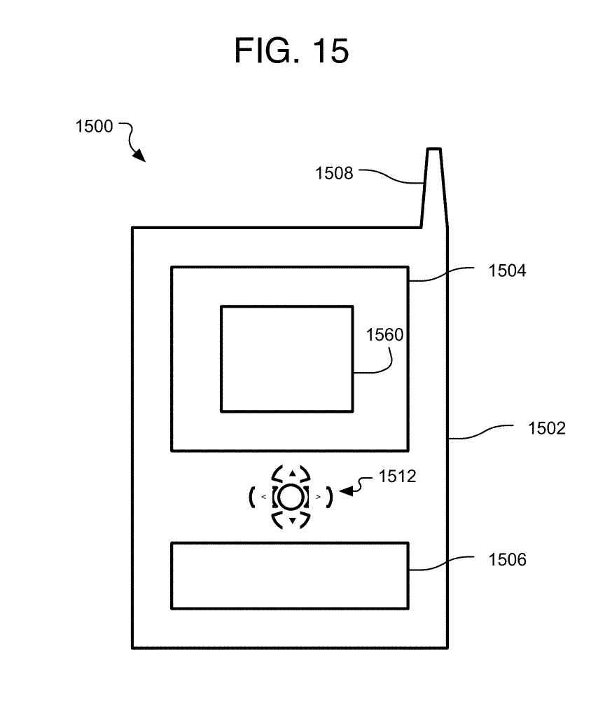

Referring to FIG. 15, a small form factor device 1500 is one example of the varying physical styles or form factors in which system 1300 or 1400 may be embodied. By this approach, device 1500 may be implemented as a mobile computing device having wireless capabilities. A mobile computing device may refer to any device having a processing system and a mobile power source or supply, such as one or more batteries, for example.

As described above, examples of a mobile computing device may include a digital still camera, digital video camera, mobile devices with camera or video functions such as imaging phones, webcam, personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 15, device 1500 may include a housing 1502, a display 1504 including a screen 1510, an input/output (I/O) device 1506, and an antenna 1508. Device 1500 also may include navigation features 1512. Display 1504 may include any suitable display unit for displaying information appropriate for a mobile computing device. I/O device 1506 may include any suitable I/O device for entering information into a mobile computing device. Examples for I/O device 1506 may include an alphanumeric keyboard, a numeric keypad, a touch pad, input keys, buttons, switches, rocker switches, microphones, speakers, voice recognition device and software, and so forth. Information also may be entered into device 1500 by way of microphone (not shown). Such information may be digitized by a voice recognition device (not shown). The implementations are not limited in this context.

Various forms of the devices and processes described herein may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further implementations.

By one example, a computer-implemented method of image processing comprises obtaining image data of at least one image capture device mounted on a head mounted display worn by a person to show the person a view of a virtual or augmented reality, the at least one image capture device being disposed to capture images of at least part of an occluded area of the person's face that is blocked from view from externally of the head mounted display; and using the image data to generate a display of the at least part of the occluded area of the person's face in a different view of the virtual or augmented reality.

By another implementation, the method may include that wherein the head mounted display is worn by a first person, and the method comprising showing the at least part of the occluded area in a view of at least one other person wearing another head mounted display showing the different view of the same virtual or augmented reality viewed by the first person; wherein the at least one image capture device is an at least one internal image capture device that provides internal images of the at least part of the occluded area; wherein the at least one image capture device forms infra-red images; and the method of claim 1 comprising converting infra-red image data from the at least one image capture device to color image data to display the at least part of the occluded area of the person's face.

By one implementation, the method comprises obtaining external image data of external images from at least one external image capture device that captures images of the person wearing the HMD covering the at least part of the occluded area; and using the external image data from the at least one external image capture device and the internal image data to generate a final image showing the occluded area and to be displayed at a head mounted display.

By one implementation the method comprises generating an appearance model to have image data of a plurality of appearance images of the at least part of the occluded area and the appearance images being provided in 3D and color; and matching the closest appearance image to an image of the at least one image capture device to use the selected appearance image to form a final non-occluded image of the face of the person to display during operation of the head mounted display; wherein the appearance images each have a different head pose, different facial expression including positions of eye brows, or different eye gaze direction than others of the appearance images.

By one implementation the method comprises generating the appearance model comprising: registering internal images of the internal image data relative to external images from an external image capture device taking images of the user and that is spaced from the head mounted display, and by using a 3D model; and warping internal images of the internal image data to the 3D model to form the appearance images; wherein the internal image data is IR image data, and wherein generating the appearance model comprising converting the IR image data to color data before warping the internal images.

By one implementation, the method comprises blending the selected appearance image showing the occluded area with a corresponding external image of at least the face of the person to form a final image to be displayed; filling missing pixel image data by an interpolation-type algorithm on the selected appearance image.

By one implementation, the method comprising: generating a 3D model of at least the person's face; generating an appearance model of the occluded area and comprising a library of appearance images of the person with different poses, facial expressions, or eye gaze directions than other appearance images; registering the location of internal images of the image data with the 3D model to register the internal images with external images from an external camera registered with the 3D model; synthesizing the internal images by finding a closest appearance image from the library and that best matches the internal image.

By yet another implementation, a computer-implemented system comprises at least one memory storing image data of at least one image capture device disposed at a head mounted display worn by a person and having a display to show the person a view of a virtual or augmented reality, wherein the at least one image capture device being disposed to capture images of at least part of an occluded area of the person's face that is blocked from view from externally of the head mounted display; at least one processor communicatively coupled to the memory; and at least one synthetic or photo-realistic avatar generation unit operatively coupled to the processor, and to be operated by: obtaining the image data of the at least one image capture device mounted on the head mounted display; and using the image data to generate a display of the at least part of the occluded area of the person's face in a different view of the virtual or augmented reality.

By another example, the system includes wherein the image capture device is an internal image capture device that generates internal images; the system comprising at least one external image capture device that generates external images of the person, and the at least one avatar generation unit using both the external and internal images to form a final image with the occluded part to display in the virtual or augmented reality; wherein the images are IR internal images, and the system comprising an appearance model unit that generates a plurality of appearance images in 3D and color and that individually provide at least a different pose, facial expression including eyebrow position, or eye gaze direction than other appearance images, and wherein the IR internal images are converted to color before warping the IR internal images to a 3D model to generate the appearance image; and a facial occlusion synthesis unit that matches IR internal images to one of the appearance images without first converting the IR internal images to color and in order to use the appearance image, at least in part, to generate an image showing the at least part of the occluded area to be displayed.

By one form, the system comprises at least one external RGB non-depth camera providing external images of the person wearing the head mounted display, and wherein the appearance model unit is operated to convert IR data to color data by at least one of: applying a mapping function to the IR internal images and using a neighborhood of pixels to determine color values of the IR internal images, and using a neural network to map at least lighting from non-occluded areas of the face to the at least part of the occluded area of the IR internal images.

By one form, the system comprises at least one external camera providing external color images of the person wearing the head mounted display; and wherein the 3D model is formed by at least one of fitting RGB video of the external camera to a generic 3D model of at least a generic person's face, and using an RGB-D depth camera as the external camera to generate a 3D face of an avatar of the person wearing the head mounted display.

By one form, the system comprises an appearance model unit to be operated by: obtaining non-occluded images of the person in various poses, facial expressions, and eye gaze directions without wearing the head mounted display; obtaining a 3D model of at least the face of the person; performing registration of the non-occluded images with the 3D model; warping the non-occluded images showing the at least part of the occluded area to be occluded by the head mounted display and warping to the 3D model; and storing the warped non-occluded images as appearance images of the appearance model.

By one form the system comprises at least one external RGB-D depth camera providing external images of the person wearing the head mounted display; a 3D model unit operated by using external images of the depth camera to form at least a face of an avatar in 3D and color as a 3D model, wherein the face shows the person wearing the head mounted display; and an appearance model unit operated by warping images of the image capture device to the 3D model to generate appearance images.

By one form, the system comprises at least one external camera providing 3D color external images of the face of the person without wearing the head mounted display; and an appearance model unit operated by: obtaining facial parameters from the images of the at least one image capture device; forming a photo-realistic avatar from the external images; and forming an appearance image of individual images of the at least one image capture device by using the facial parameters from the individual image on the photo-realistic avatar; and storing a plurality of the appearance images; a facial occlusion synthesis unit operated by matching an image of the image capture device to the closest stored appearance image.

By one form, the system comprises at least one external camera providing external color images of the person without wearing the head mounted display; at least one facial occlusion synthesis unit being operated by: obtaining external camera parameters; modifying an avatar model of at least a face of the person and modified by the parameters; and warping the images of the at least one image capture device onto the parameterized avatar model to generate an image to be refined to be displayed.

By yet another implementation, a computer-implemented system of generating a virtual or augmented reality comprising: at least one head mounted display worn by a person and having a display to show the person a view of a virtual or augmented reality, and having at least one image capture device being disposed to capture images of at least part of an occluded area of the person's face that is blocked from view from externally of the head mounted display; at least one memory storing image data forming the images; at least one processor communicatively coupled to the memory; and at least one synthetic or photo-realistic avatar generation unit operatively coupled to the processor, and to be operated by: obtaining the image data of the at least one image capture device mounted on the head mounted display; and using the image data to generate a display of the at least part of the occluded area of the person's face in a different view of the virtual or augmented reality. This system also may include any of the features described directly above.

By one approach, at least one computer readable article comprises a plurality of instructions that in response to being executed on a computing device, cause the computing device to operate by obtaining image data of at least one image capture device mounted on a head mounted display worn by a person to show the person a view of a virtual or augmented reality, the at least one image capture device being disposed to capture images of at least part of an occluded area of the person's face that is blocked from view from externally of the head mounted display; and using the image data to generate a display of the at least part of the person's face in a different view of the virtual or augmented reality.

By another approach, the instructions cause the computing device to be operated by generating a 3D model of at least the person's face; generating an appearance model of the occluded area and comprising a library of appearance images of the person with different poses, facial expressions, or eye gaze directions than other appearance images; registering the location of internal images of the image data with the 3D model to register the internal images with external images from an external camera registered with the 3D model; synthesizing the internal images by finding a closest appearance image from the library and that best matches the internal image; blending the appearance image with a face displayed on a corresponding one of the external images to form a synthesized image of the occluded area; and merging the synthesized image with other parts of the corresponding external image.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

What is claimed is:

1. A computer-implemented method of image processing, comprising:
obtaining image data of at least one image capture device mounted on a head mounted display worn by a person to show the person a view of a virtual or augmented reality, the at least one image capture device being disposed to capture images of at least part of an occluded area of the person's face that is blocked from view from externally of the head mounted display; and
using the image data to generate a display of the at least part of the occluded area of the person's face in a different view of the virtual or augmented reality.

2. The method of claim 1, wherein the head mounted display is worn by a first person, and the method comprising showing the at least part of the occluded area in a view of at least one other person wearing another head mounted display showing the different view of the same virtual or augmented reality viewed by the first person.

3. The method of claim 1 wherein the at least one image capture device is an at least one internal image capture device that provides internal images of the at least part of the occluded area, the method comprising:
obtaining external image data of external images from at least one external image capture device that captures images of the person wearing the HMD covering the at least part of the occluded area;
using the external image data from the at least one external image capture device and the internal image data to generate a final image showing the occluded area and to be displayed at a head mounted display.

4. The method of claim 1 wherein the at least one image capture device forms infra-red images.

5. The method of claim 1 comprising converting infra-red image data from the at least one image capture device to color image data to display the at least part of the occluded area of the person's face.

6. The method of claim 1, comprising generating an appearance model to have image data of a plurality of appearance images of the at least part of the occluded area and the appearance images being provided in 3D and color; and
matching the closest appearance image to an image of the at least one image capture device to use the selected appearance image to form a final non-occluded image of the face of the person to display during operation of the head mounted display.

7. The method of claim 6 wherein the appearance images each have a different head pose, different facial expression including positions of eye brows, or different eye gaze direction than others of the appearance images.

8. The method of claim 6 wherein generating the appearance model comprising:
registering internal images of the internal image data relative to external images from an external image capture device taking images of the user and that is spaced from the head mounted display, and by using a 3D model; and
warping internal images of the internal image data to the 3D model to form the appearance images.

9. The method of claim 8 wherein the internal image data is IR image data, and wherein generating the appearance model comprising converting the IR image data to color data before warping the internal images.

10. The method of claim 6 comprising blending the selected appearance image showing the occluded area with a corresponding external image of at least the face of the person to form a final image to be displayed.

11. The method of claim 6 comprising filling missing pixel image data by an interpolation-type algorithm on the selected appearance image.

12. The method of claim 1 comprising:
generating a 3D model of at least the person's face;
generating an appearance model of the occluded area and comprising a library of appearance images of the person with different poses, facial expressions, or eye gaze directions than other appearance images;
registering the location of internal images of the image data with the 3D model to register the internal images with external images from an external camera registered with the 3D model;
synthesizing the internal images by finding a closest appearance image from the library and that best matches the internal image;
blending the appearance image with a face displayed on a corresponding one of the external images to form a synthesized image of the occluded area; and
merging the synthesized image with other parts of the corresponding external image.

13. A computer-implemented system comprising:
at least one memory storing image data of at least one image capture device disposed at a head mounted display worn by a person and having a display to show the person a view of a virtual or augmented reality, wherein the at least one image capture device being disposed to capture images of at least part of an occluded area of the person's face that is blocked from view from externally of the head mounted display;
at least one processor communicatively coupled to the memory; and
at least one synthetic or photo-realistic avatar generation unit operatively coupled to the processor, and to be operated by:
obtaining the image data of the at least one image capture device mounted on the head mounted display; and
using the image data to generate a display of the at least part of the occluded area of the person's face in a different view of the virtual or augmented reality.

14. The system of claim 13 wherein the image capture device is an internal image capture device that generates internal images; the system comprising at least one external image capture device that generates external images of the person, and the at least one avatar generation unit using both the external and internal images to form a final image with the occluded part to display in the virtual or augmented reality.

15. The system of claim 13 wherein the images are IR internal images, and the system comprising an appearance model unit that generates a plurality of appearance images in 3D and color and that individually provide at least a different pose, facial expression including eyebrow position, or eye gaze direction than other appearance images, and wherein the IR internal images are converted to color before warping the IR internal images to a 3D model to generate the appearance image; and
a facial occlusion synthesis unit that matches IR internal images to one of the appearance images without first converting the IR internal images to color and in order to use the appearance image, at least in part, to generate an image showing the at least part of the occluded area to be displayed.

16. The system of claim 15 comprising at least one external RGB non-depth camera providing external images of the person wearing the head mounted display, and wherein the appearance model unit is operated to convert IR data to color data by at least one of:
applying a mapping function to the IR internal images and using a neighborhood of pixels to determine color values of the IR internal images, and
using a neural network to map at least lighting from non-occluded areas of the face to the at least part of the occluded area of the IR internal images.

17. The system of claim 15 comprising at least one external camera providing external color images of the person wearing the head mounted display; and wherein the 3D model is formed by at least one of fitting RGB video of the external camera to a generic 3D model of at least a generic person's face, and using an RGB-D depth camera as the external camera to generate a 3D face of an avatar of the person wearing the head mounted display.

18. The system of claim 13 comprising an appearance model unit to be operated by:
obtaining non-occluded images of the person in various poses, facial expressions, and eye gaze directions without wearing the head mounted display;
obtaining a 3D model of at least the face of the person;
performing registration of the non-occluded images with the 3D model;
warping the non-occluded images showing the at least part of the occluded area to be occluded by the head mounted display and warping to the 3D model; and
storing the warped non-occluded images as appearance images of the appearance model.

19. The system of claim 13 comprising:
at least one external RGB-D depth camera providing external images of the person wearing the head mounted display;
a 3D model unit operated by using external images of the depth camera to form at least a face of an avatar in 3D and color as a 3D model, wherein the face shows the person wearing the head mounted display; and
an appearance model unit operated by warping images of the image capture device to the 3D model to generate appearance images.

20. The system of claim 13 comprising:
at least one external camera providing 3D color external images of the face of the person without wearing the head mounted display; and
an appearance model unit operated by:
obtaining facial parameters from the images of the at least one image capture device;
forming a photo-realistic avatar from the external images; and
forming an appearance image of individual images of the at least one image capture device by using the facial parameters from the individual image on the photo-realistic avatar; and
storing a plurality of the appearance images.

21. The system of claim 20 comprising a facial occlusion synthesis unit operated by matching an image of the image capture device to the closest stored appearance image.

22. The system of claim 13 comprising:
at least one external camera providing external color images of the person without wearing the head mounted display;
at least one facial occlusion synthesis unit being operated by:
obtaining external camera parameters;
modifying an avatar model of at least a face of the person and modified by the parameters; and
warping the images of the at least one image capture device onto the parameterized avatar model to generate an image to be refined to be displayed.

23. A computer-implemented system of generating a virtual or augmented reality comprising:
at least one head mounted display worn by a person and having a display to show the person a view of a virtual or augmented reality, and having at least one image capture device being disposed to capture images of at least part of an occluded area of the person's face that is blocked from view from externally of the head mounted display;
at least one memory storing image data forming the images;
at least one processor communicatively coupled to the memory; and
at least one synthetic or photo-realistic avatar generation unit operatively coupled to the processor, and to be operated by:
obtaining the image data of the at least one image capture device mounted on the head mounted display; and
using the image data to generate a display of the at least part of the occluded area of the person's face in a different view of the virtual or augmented reality.

24. At least one computer readable article comprising a plurality of instructions that in response to being executed on a computing device, causes the computing device to operate by:
obtaining image data of at least one image capture device mounted on a head mounted display worn by a person to show the person a view of a virtual or augmented reality, the at least one image capture device being disposed to capture images of at least part of an occluded area of the person's face that is blocked from view from externally of the head mounted display; and
using the image data to generate a display of the at least part of the person's face in a different view of the virtual or augmented reality.

25. The article of claim 24 wherein the instructions cause the computing device to operate by:
generating a 3D model of at least the person's face;
generating an appearance model of the occluded area and comprising a library of appearance images of the person with different poses, facial expressions, or eye gaze directions than other appearance images;
registering the location of internal images of the image data with the 3D model to register the internal images with external images from an external camera registered with the 3D model;
synthesizing the internal images by finding a closest appearance image from the library and that best matches the internal image;
blending the appearance image with a face displayed on a corresponding one of the external images to form a synthesized image of the occluded area; and
merging the synthesized image with other parts of the corresponding external image.
